(19) United States
(12) Patent Application Publication
(10) Pub. No.: US 2026/0004110 A1
(43) Pub. Date: Jan. 1, 2026

(54) ARTIFICIAL INTELLIGENCE (AI)-BASED SYSTEM AND METHOD FOR GENERATING GENERATIVE AI BASED SOLUTION

(71) Applicant: ACCENTURE GLOBAL SOLUTIONS LIMITED, Dublin 4 (IE)

(72) Inventors: Luke HIGGINS, West Pymble (AU); Koushik M. VIJAYARAGHAVAN, Chennai (IN); Dipankar RAYBARMAN, Laverton (AU); Leon WHINE, Melbourne (AU); Ilangovan SIVAKUMAR, Chennai (IN); Vaibhav SUNEJA, Melbourne (AU); Pradeep Kumar SENAPATI, Bangalore (IN); Koustuv JANA, Bangalore (IN); Vijeth Srinivas HEGDE, Bangalore (IN); Rajesh NAGARAJAN, Chennai (IN); Jiayi CHEN, Melbourne (AU); Saravana Babu RAMAN, Melbourne (AU); Elles LE, Kensington (AU); Jin QIAN, Melbourne (AU)

(73) Assignee: ACCENTURE GLOBAL SOLUTIONS LIMITED, Dublin 4 (IE)

(21) Appl. No.: 18/759,058

(22) Filed: Jun. 28, 2024

(51) Int. Cl. G06N 3/0475; G06N 3/045

(52) U.S. Cl. CPC G06N 3/0475; G06N 3/045

(57) ABSTRACT

Systems and methods for generating generative AI based solution are disclosed. A system receives a request for generating the generative AI (GenAI) based solution. The system classifies the received request into solution patterns and performs actions corresponding to at least one of the solution patterns. The system extracts a metadata from the received request and the actions based on the type of GenAI based solution to be generated. Further, the system segments the extracted metadata into data segments and generates a vector representation of the data segments. The system generates the GenAI based solution corresponding to the received request based on the generated vector representation. The system validates the GenAI based solution large language model (LLM). The system continuously updates the LLM and the vector-based machine learning model with the validated GenAI based solution and user feedback. The system outputs the GenAI based solution on a user interface.

### TECHNICAL FIELD

The present disclosure generally relates to artificial intelligence and machine learning systems and, more specifically, relates to Artificial Intelligence (AI)-based system and a method for processing datasets and generating generative AI based solution.

### BACKGROUND

Generative Artificial Intelligence (AI)-based solutions have a wide range of applications across various domains such as content generation, content enhancement, restoration, and the like. However, the generative AI-based solutions, although providing promising results, face several challenges in development and deployment of specific software solutions or frameworks for specific use cases. Some common problems associated with generative AI solutions may include data quality issues, training complexity issues, data security and privacy risks, efficiency, and domain-specific challenges.

Further, existing generative AI models may face challenges such as generalizing data to unseen or out-of-distribution data, leading to poor performance or unexpected behaviors in real-world applications. Also, the generative AI models may be potentially exploited to generate synthetic data that resembles sensitive or confidential information, hence posing risks to privacy and security. Moreover, deploying generative AI solutions may pose challenges in terms of computational resources, latency, and cost-effectiveness. Training the existing generative AI models may be computationally intensive and time-consuming, which may require complex hardware infrastructure and advanced optimization techniques.

In recent times, a substantial number of knowledge base documents, standard operating procedures, financial operational documents, and other such documents, may be created by organizations for multiple purposes. Some examples of the documents may include policies, procedures, guidelines, project plans, reports, agreements, legal documents, contracts, Standard operating procedures (SOPs), manuals, and guidelines. The usage of these documents becomes challenging when the volume of the documents are substantially increased. There are several repetitive problems faced by a personnel in day-to-day routine while performing a plurality of tasks related to a plurality of use cases. For example, typically these tasks are performed manually by a person who require skills and expertise for performing these tasks. Moreover, these tasks require analysis of a huge volume of data, correlating them, and performing some action after the analysis. Conventionally, these documents are created twice if there are no information readily available in data sources. Furthermore, these tasks require performing a search using exact keywords when users are beginners and are not aware of context of these tasks that are to be performed.

### SUMMARY

This section is provided to introduce certain objects and aspects of the present disclosure in a simplified form that are further described below in the detailed description. This summary is not intended to identify the key features or the scope of the claimed subject matter.

In one aspect, the present disclosure relates to a system for generating GenAI based solution. The system includes a processor and a memory communicably coupled to the processor. The processor is caused to receive a request for generating a generative AI (GenAI) based solution from a user. The request includes a query associated with at least one of a use case, a domain and product requirements. The processor is caused to classify the received request into a plurality of solution patterns. Further, each solution pattern indicates a type of generative AI based solution to be generated for the request. The processor is caused to perform a plurality of actions corresponding to at least one of the plurality of solution patterns based on the received request and extract a metadata from the received request and the plurality of actions based on the type of generative AI based solution to be generated. Further, the processor is caused to segment the extracted metadata into a plurality of data segments based on the plurality of solution patterns, and the request. The processor is caused to generate a vector representation of the plurality of data segments by embedding the plurality of data segments using a vector-based machine learning model. The processor is caused to generate a generative AI based solution corresponding to the received request based on the generated vector representation of the plurality of data segments. The processor is caused to provide a response source for the generative AI based solution with a confidence level. The processor is further caused to validate the generative AI based solution using at least one large language model (LLM). The processor is caused to continuously update the at least one large language model and the vector-based machine learning model with the validated generative AI based solution and a user feedback corresponding to the validated generative AI based solution. The processor is caused to output the generative AI based solution to the received request on a user interface.

In another aspect, the present disclosure relates to a method for generating GenAI based solution. The method includes receiving, by a processor, a request for generating a generative AI (GenAI) based solution from a user. The request includes a query associated with at least one of a use case, a domain and product requirements. The method includes classifying, by the processor, the received request into a plurality of solution patterns. Further, each solution pattern indicates a type of generative AI based solution to be generated for the request. The method includes performing, by the processor, a plurality of actions corresponding to at least one of the plurality of solution patterns based on the received request and extract a metadata from the received request and the plurality of actions based on the type of generative AI based solution to be generated. Further, the method includes segmenting, by the processor, the extracted metadata into a plurality of data segments based on the plurality of solution patterns, and the request. The method includes generating, by the processor, a vector representation of the plurality of data segments by embedding the plurality of data segments using a vector-based machine learning model. The method includes generating, by the processor, a generative AI based solution corresponding to the received request based on the generated vector representation of the plurality of data segments. The method includes providing, by the processor, a response source for the generative AI based solution with a confidence level. The method further includes validating, by the processor, the generative AI based solution using at least one large language model (LLM). The method includes continuously updating, by the processor, the at least one large language model and the vector-based machine learning model with the validated generative AI based solution and a user feedback corresponding to the validated generative AI based solution. The method includes outputting, by the processor, the generative AI based solution to the received request on a user interface.

In another aspect, the present disclosure relates to a non-transitory computer readable medium comprising a processor-executable instructions that cause a processor to receive a request for generating a generative AI (GenAI) based solution from a user. The request includes a query associated with at least one of a use case, a domain and product requirements. The processor classifies the received request into a plurality of solution patterns. Further, each solution pattern indicates a type of generative AI based solution to be generated for the request. The processor performs a plurality of actions corresponding to at least one of the plurality of solution patterns based on the received request and extract a metadata from the received request and the plurality of actions based on the type of generative AI based solution to be generated. Further, the processor segments the extracted metadata into a plurality of data segments based on the plurality of solution patterns, and the request. The processor generates a vector representation of the plurality of data segments by embedding the plurality of data segments using a vector-based machine learning model. The processor generates a generative AI based solution corresponding to the received request based on the generated vector representation of the plurality of data segments. The processor provides a response source for the generative AI based solution with a confidence level. The processor validates the generative AI based solution using at least one large language model (LLM). The processor continuously updates the at least one large language model and the vector-based machine learning model with the validated generative AI based solution and a user feedback corresponding to the validated generative AI based solution. The processor outputs the generative AI based solution to the received request on a user interface.

To further clarify the advantages and features of the present disclosure, a more particular description of the disclosure may follow by reference to specific embodiments thereof, which are illustrated in the appended figures. It is to be appreciated that these figures depict only typical embodiments of the disclosure and are therefore not to be considered limiting in scope. The disclosure may be described and explained with additional specificity and detail with the appended figures.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It may be appreciated by those skilled in the art that invention of such drawings include the invention of electrical components, electronic components or circuitry commonly used to implement such components.

FIG. 1 illustrates an exemplary block diagram representation of a network architecture in which a system may be implemented for generating a GenAI-based solution, in accordance with embodiments of the present disclosure.

FIG. 2 illustrates an exemplary block diagram representation of a computer-implemented system, such as those shown in FIG. 1, capable of generating the GenAI-based solution, in accordance with embodiments of the present disclosure.

FIG. 3 illustrates an implementation of the GenAI based solution for a few automation use cases, in accordance with an embodiment of the present disclosure.

FIGS. 4A and 4B illustrate a block diagram representation of a high-level architecture implementing the GenAI based solution for a few use cases, in accordance with an embodiment of the present disclosure.

FIG. 5A is a simplified block diagram representation depicting the integration of a processing model with other applications using application programming interfaces (API), in accordance with an embodiment of the present disclosure.

FIG. 5B is a simplified block diagram representation depicting a technology stack of the processing model, in accordance with an embodiment of the present disclosure.

FIG. 6A illustrates a process flow depicting a document search workflow, in accordance with an embodiment of the present disclosure.

FIG. 6B illustrates a process flow depicting a document uploading workflow, in accordance with an embodiment of the present disclosure.

FIG. 7A illustrates a simplified block diagram representation of an orchestration model, in accordance with an embodiment of the present disclosure.

FIG. 7B illustrates a process flow depicting a workflow for resolving multiple sources, in accordance with an embodiment of the present disclosure.

FIG. 7C illustrates a process flow depicting the interaction of API layers with multiple LLMs, in accordance with an embodiment of the present disclosure.

FIG. 8 illustrates a prompt builder workflow, in accordance with an embodiment of the present disclosure.

FIG. 9A illustrates a flowchart depicting a method for generating a code, in accordance with an embodiment of the present disclosure.

FIG. 9B illustrates a flowchart depicting a method for incrementally fixing issues in generating the code, in accordance with an embodiment of the present disclosure.

FIGS. 10A, 10B and 10C illustrate an example representation of a user interface (UI) depicting delivery scores as a result of document analysis and data querying through chatbot, in accordance with an embodiment of the present disclosure.

FIG. 11 illustrates a simplified block diagram representation of a high-level architecture to implement multiple clients GenAI solutions in a cloud environment, in accordance with an embodiment of the present disclosure.

FIG. 12A is a simplified block diagram representation for secure data storage for multiple clients as shown in FIG. 11, in accordance with an embodiment of the present disclosure.

FIG. 12B is a simplified block diagram representation of Role Based Access Control (RBAC) to keep client data secure for multiple clients as shown in FIG. 11, in accordance with an embodiment of the present disclosure.

FIG. 13A is a simplified block diagram representation of a dedicated model for secure data storage of multiple clients as shown in FIG. 11, in accordance with an embodiment of the present disclosure.

FIG. 13B is a simplified block diagram representation of a shared model for secure data storage of multiple clients as shown in FIG. 11, in accordance with an embodiment of the present disclosure.

FIG. 14A illustrates an exemplary use case of Fast tracking the resolution of high priority incidents implementation using GenAI solutions, in accordance with an embodiment of the present disclosure.

FIG. 14B illustrates an exemplary use case of automation and knowledge creation implementation using GenAI solutions, in accordance with an embodiment of the present disclosure.

FIG. 14C illustrates an exemplary use case of report generation using GenAI solutions, in accordance with an embodiment of the present disclosure.

FIG. 14D illustrates an exemplary use case of question-and-answer conversational chat using GenAI solutions, in accordance with an embodiment of the present disclosure.

FIGS. 15A to 15J illustrate an exemplary use case depicting generation of a workflow prompt builder, script generation and a workflow generation associated with a workflow manager (WFM) application, in accordance with an embodiment of the present disclosure.

FIGS. 16A and 16B illustrate an exemplary use case of a GenAI powered generation-oriented tool, in accordance with an embodiment of the present disclosure.

FIG. 17 illustrates an exemplary use case of enriching data while pulling data through service integrator, in accordance with an embodiment of the present disclosure.

FIG. 18 illustrates a flow chart depicting a method for generating GenAI based solution, in accordance with the embodiments of the present disclosure.

FIG. 19 illustrates an exemplary block diagram representation of a hardware platform for implementation of the disclosed system, in accordance with embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It may be apparent, however, that embodiments of the present disclosure may be practiced without these specific details. Several features described hereafter may each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments may provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it may be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, and the like. When a process corresponds to a function, its termination may correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It may be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

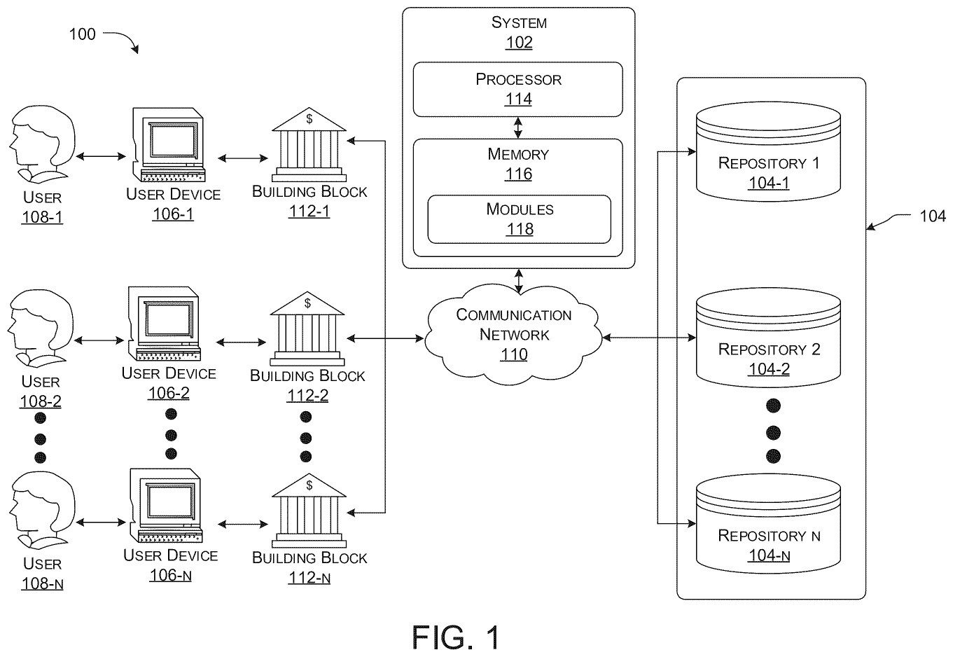

Referring now to the drawings, and more particularly to FIG. 1 through FIG. 19, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 in which a system 102 may be implemented for generating system architecture representation by implementing machine learning (ML) models, in accordance with embodiments of the present disclosure. The network architecture 100 may include the system 102, one or more repositories 104-1, 104-2, . . . , and 104-N (individually referred to as the repository 104, and collectively referred to as the repositories 104), and at least one user (collectively referred for a user 108-1, a user 108-2, a user 108-N). The users 108-1 to 108-N are collectively referred to as ‘the user 108’ or ‘the at least one user 108’. Each of the at least one user 108-1-108-N is associated with a user device 106-1, a user device 106-2, . . . , a user device 106-N. In an embodiment, the system 102 may be a server system. Some examples of the server systems may be, but are not limited to, a cloud server, a centralized server, a rack server, a network server, a computer-based server, on premise server, a dedicated server, a remote server, and the like. All the system 102 of the network architecture 100 may be communicatively coupled to the user device 106 via a communication network 110. The communication network 110 may be a wired communication network and/or a wireless communication network.

The at least one user 108 may be an individual, an administrator, a vendor, a technician, a worker, a specialist, an instructor, a supervisor, a team, an entity, an organization, a company, a facility, a bot, any other user, and combination thereof. In an embodiment, the user 108 may be associated with organization 112-1, 112-2, . . . 112-N (as shown in FIG. 1). The entities such as the organization 112-1 to 112-N (collectively referred to as ‘the organization 112’) may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like.

Further, the user devices 106-1 to 106-N may be used to provide input and/or receive output to/from the system 102. The user devices 106-1 to 106-N may present to the user one or more user interfaces for the user 108 to interact with the system 102 for processing large datasets. The user devices 106-1 to 106-N may be at least one of, an electrical, an electronic, an electromechanical, and a computing device. The user devices 106-1 to 106-N may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Furthermore, the system 102 may be implemented by way of a single device or a combination of multiple devices that may be operatively connected or networked together. The system 102 may be implemented in hardware or a suitable combination of hardware and software. Further, the system 102 may include one or more processor(s) 114, and a memory 116. The memory 112 may include a plurality of modules 118. The system 102 may be a hardware device including the processor 114 executing machine-readable program instructions for generating at least the system architecture representation. Execution of the machine-readable program instructions by the processor 114 may enable the system 102 to perform the one or more operations described herein related to the generating generative AI based solution. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more processors 114 may include, for example, microprocessors, microcomputers, microcontrollers, digital signal processors, central processing units, state machines, logic circuits, and/or any devices that manipulate data or signals based on operational instructions. Among other capabilities, the processor 114 may fetch and execute computer-readable instructions in the memory 116 operationally coupled with the system 102 for performing tasks such as generating the generative AI based solution, data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art may appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, Bluetooth adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art may recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may receive a request for generating a generative AI (GenAI) based solution from a user (e.g., the user 108-1). The request includes a query associated with at least one of a use case, a domain, and product requirements. For description purposes, the user 108-1 is considered as the user associated with the organization 112 who wishes to generate the GenAI based solution for data processing (e.g., search information within a specific set of documents of a particular type). The use case, domain, and product requirements may be source data. The source data may be uploaded or transmitted to the system 102 by the user 108-1 in any format such as pdf, word, CSV, excel, or text. The system 102 may be configured to transform the content into a machine-readable format and store the transformed content in the repository 104 for further processing. The system 102 may be configured to prepare a knowledge base repository effectively that helps to solve various Gen AI issues such as processing large excel sheets, processing images, etc.

In an exemplary embodiment, the system 102 classifies the received request into a plurality of solution patterns. Further, each solution pattern indicates a type of generative AI-based solution to be generated for the request. Some non-limiting examples of the solution patterns may include a generation pattern, a completion pattern, a synthesis pattern, an analysis pattern, a summarization pattern, a sentiment analysis pattern, a remediation pattern, a segmentation pattern, a translation pattern, question and answers, and classification.

In an exemplary embodiment, the system 102 performs a plurality of actions corresponding to at least one of the plurality of solution patterns based on the received request. In particular, the system 102 identifies a plurality of tasks associated with the plurality of solution patterns based on the received requirements. Thereafter, the system 102 identifies a type of input parameters and a type of output parameters associated with the identified plurality of tasks based on the type of tasks, task properties, and sequence of execution of each task. Further, the system 102 executes the plurality of tasks associated with the plurality of solution patterns based on the identified type of input parameters and the type of output parameters.

In addition, the system 102 receives a solution pattern selected for performing the plurality of actions. Further, the system 102 pre-processes the received request based on the solution pattern and generates a graphical user-interface (GUI) corresponding to the solution pattern. The system 102 further determines a plurality of solution pattern properties associated with the solution pattern and performs the plurality of actions on the generated GUI based on the determined plurality of solution pattern properties.

In an exemplary embodiment, the system 102 extracts metadata from the received request and the plurality of actions based on the type of generative AI based solution to be generated. Specifically, the system 102 extracts plain text from the received request and the plurality of actions performed. Then, the system 102 determines the metadata associated with the extracted plain text. The metadata may include use case properties, type of product requirements, content of the use case, domain category, document version information, user defined inputs, and additional requests from the user 108.

In an exemplary embodiment, the system 102 is configured to segment the extracted metadata into a plurality of data segments based on the plurality of solution patterns, and the request. In an exemplary embodiment, the system 102 generates a vector representation of the plurality of data segments by embedding the plurality of data segments using a vector-based machine learning model. In particular, the system 102 is configured to embed the plurality of data segments using the vector-based machine learning model by merging raw data of the received request with the extracted metadata and a vector value. The system 102 generates the vector representation of the embedded plurality of data segments. Thereafter, the system 102 stores the generated vector representation in a corresponding vector database node.

In an exemplary embodiment, the system 102 generates a generative AI based solution corresponding to the received request based on the generated vector representation of the plurality of data segments. More specifically, the system 102 is configured to perform a similarity search for the generated vector representation by comparing the generated vector representation with at least one vector representation of the pre-stored plurality of data segments. The system 102 may perform natural language processing (NLP) based keyword search and semantic search to improve accuracy. Further, the system 102 determines a similarity score for the generated vector representation based on results of the similarity search and a priority level of the generated vector representation. The system 102 further generates the generative AI based solution corresponding to the received request based on the determined similarity score. The system 102 generates the generative AI based solution based at least on mapping the generated vector representation with at least one vector representation of the pre-stored plurality of data segments. Then the system 102 generates an embedded response including the mapped data segments and a part of the received request and determines whether the generated embedded response complies with predefined organization rules. Further, the system 102 converts the generated embedded response to a large language model (LLM) readable file based on the results of determination. Lastly, the system 102 generates the generative AI based solution.

Furthermore, generating the generative AI based solution may include generating answers to at least one question from the user using a vector database; generating answers to automated voice mails; generating summary of the automated voice calls; generating a document on root cause analysis of a use case, generating a plurality of test cases from a plurality of user stories; generating explanation of a code, generating a test data for test cases, co-relating test cases with the plurality of user stories, analyzing large relational data and recommending decisions, analyzing diagrams in architecture documents, generating documents from a chat history, generating a document from a template, generating a source code from a requirement document generating a plurality of artificial intelligence (AI)-based insights from an indexed data and generating workflows for the use case. The workflows are generated using code scripts. The code scripts are generated using prompts.

In an exemplary embodiment, the system 102 provides a response source for the generative AI based solution with a confidence level. This results in providing accurate automation decision. Further, the system 102 validates the generative AI based solution using at least one large language model (LLM). Specifically, the system 102 determines the intent of the received request from the user by parsing the contents of the received request. The system 102 determines an LLM for validating the generative AI based solution based on the determined intent and by comparing the contents of the received request with a plurality of pre-stored LLM descriptions. Further, the system 102 determines a token usage limit of the determined LLM by accessing LLM properties of the determined LLM, and routes the generative AI based solution to the determined LLM for validation. Thereafter, the system 102 applies trained large language models to the generative AI based solution based on the determined intent. The system 102 determines a confidence score associated with the generative AI based solution based on the results of the application of the trained large language models. The system 102 updates the generative AI based solution based on the determined confidence score and generates a response to the received request. The response includes the updated generative AI based solution.

In an exemplary embodiment, the system 102 continuously update the at least one large language model and the vector-based machine learning model with the validated generative AI based solution and a user feedback corresponding to the validated generative AI based solution. In an exemplary embodiment, output the generative AI based solution to the received request on a user interface.

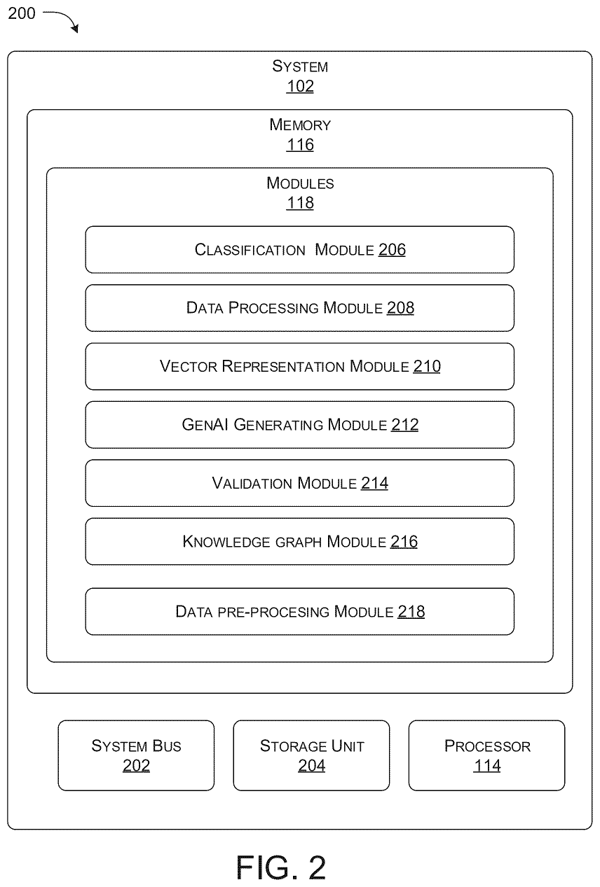

FIG. 2 illustrates an exemplary block diagram representation of a computer-implemented the system 102, such as those shown in FIG. 1, capable of data processing and generating generative AI based solution, in accordance with embodiments of the present disclosure. The system 102 may also function as a computer-implemented system 102. The system 102 may include the one or more processors 114, the memory 116, and a storage unit 204. The one or more processors 114, the memory 116, and the storage unit 204 are communicatively coupled through a system bus 202 or any similar mechanism. The memory 116 includes the plurality of modules 118 in the form of programmable instructions executable by the one or more processors 114.

Further, the plurality of modules 118 includes a classification module 206, a data processing module 208, a vector representation module 210, GenAI generating module 212, and a validation module 214.

The one or more processors 114, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more processors 114 may also include embedded controllers, such as generic or programmable logic devices or arrays, application-specific integrated circuits, single-chip computers, and the like.

The memory 116 may be a non-transitory volatile memory and a non-volatile memory. The memory 116 may be coupled to communicate with the one or more hardware processors 114, such as being a computer-readable storage medium. The one or more hardware processors 114 may execute machine-readable instructions and/or source code stored in the memory 116. A variety of machine-readable instructions may be stored in and accessed from the memory 116. The memory 116 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 116 may include the plurality of modules 118 stored in the form of machine-readable instructions on any of the above-mentioned storage media and may be in communication with and executed by the one or more processors 114.

The storage unit 204 may be a cloud storage or a database such as those shown in FIG. 1. The storage unit 204 may store, but is not limited to, metadata, a plurality of datasets, training dataset, test dataset, classified test dataset, expanded training dataset, a classified test dataset, ranked list of recommended metrics, mitigation strategy, enterprise product, effort scores, re-selected datasets, re-trained models, performance metrics, model fairness level, explainability level, a dataset size, a model dimensionality, and a memory resource, plurality of AI models, K data samples, automatic pipelines for dataset any other data, and combinations thereof. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the processor 114 receives a request for generating a generative AI (GenAI) based solution from the user 108. The request includes queries associated with at least one of a use case, a domain and product requirements. Thereafter, the classification module 206 classifies the received request into a plurality of solution patterns. Further, each solution pattern indicates a type of generative AI-based solution to be generated for the request. Furthermore, the processor 114 (or the classification module 206) performs the plurality of actions corresponding to the plurality of solution patterns based on the received request. Some non-limiting examples of the solution patterns may include a generation pattern, a completion pattern, a synthesis pattern, an analysis pattern, a summarization pattern, a sentiment analysis pattern, a remediation pattern, a segmentation pattern, a translation pattern, question and answers, and classification.

In an exemplary embodiment, the generation pattern may apply to generating content from scratch, for example—generating new test cases for a user story, generating a new incident resolution document, generating a new standard operating procedure document, generating new code, and the like. In certain instances, the generation pattern may apply to generating based on the context. For example, generate new test cases for the already existing user stories. The approach disclosed in the present disclosure uploads the already existing user stories, searches for the user stories, and generates prompts automatically to generate test cases for the requested user stories. In the case of handling (summarizing) large documents, the system 102 may break the document into smaller pieces and sequentially perform summarization such that the context is not missed. Further, the system 102 is capable of handling large relational data sets. For example, the data in an Excel sheet or database is normally structured. The large Excel sheet is batched and uploaded asynchronously. Each row in the Excel sheet is stored as key value pair such that the columns may be filtered after a semantic search. Furthermore, the system 102 is configured with dynamic prompting. For example, a GenAI query may be performed for each row in the result data. In this scenario, the complete prompt may be generated referring to each row in the result set, using a prompt template. Also, it is important to return generative AI data for each row in the data set, for example, generate test cases for each use case. In this scenario, the data may be broken into batches as per the token limit, they are processed in parallel and then combined at the end to get the final result.

In an exemplary embodiment, the completion pattern may apply to generating the content based on partially supplied context and objectives. The generation of the missing nodes in the hierarchy is an example of a completion pattern. Another example may be to complete a partially filled-up form based on a given context. The partially completed documents may be uploaded into the system 102 and then simple questions may filter the context automatically and form the prompts to generate the contents asked in the questions. To form the context, multiple data sets may be joined. This corresponds to a reusable way of joining the datasets and forming the prompts.

In an exemplary embodiment, the synthesis pattern is applicable to combine multiple components together, understand the components, derive the relations, and answer questions or generate new content based on the combined information. For example, when features, user stories, test cases, and code modules are uploaded from existing projects and questions are listed such as the impact of a change is, it may require combining all information and step by step establishing the relation between various components and then answer the question or generate new content. Hence, all the documents may be uploaded together into the system 102, and automated prompts may be generated that may help to identify which component is related to others.

In an exemplary embodiment, the analysis pattern is applied to analyze previously uploaded documents in the system 102 and helps make decisions. For example: finding the automation opportunities based on historical incidents for an IT project. It is to be noted that the analysis of the document requires the document to be stored in a particular format such that it may identify the fields efficiently. The system 102 pre-processes the document and stores it as a key value pair such that it may be searched using vector search, filtered, and sent to LLM for question answer with using vector search, filtered, and sent to LLM for the question.

In an exemplary embodiment, the summarization pattern may transform contents from one format to another and it may not be accurately digitized. For example: when transforming voice to text, the words may not be interpreted correctly. This pattern summarizes the document with correct English and human-readable format, which may then be referred to as a knowledge base. Hence, the system 102 may automatically listen to the service desk conversation, transform it into text, summarize content, and index the data. This may then be used for actions such as, for example, but not limited to, question answers or suggesting solutions to support agents' real-time.

In an exemplary embodiment, the sentiment analysis pattern is applied to provide the ability to gain an understanding of the sentiment of customer interactions e.g., understanding the health of a customer journey. The system 102 takes this sentiment as an input to decide the next best action if there are negative sentiments detected and uses the positive sentiments for further learning.

In an exemplary embodiment, the remediation pattern provides the next best action, for example, completing incident RCA and resolution recommendations. The remediation pattern may read events from multiple sources, read historical data, and prepare a consolidated root cause analysis along with a suggested code snippet to resolve the issue.

In an exemplary embodiment, the segmentation pattern organizes and extracts entities from unstructured documents, for example, key value pairs from a contract. In particular, the segmentation pattern digitizes content from various formats such as, for example, but not limited to, images, and voice. It may then store the digitized content in the repository 104 which may be referred to for further actions.

In an exemplary embodiment, the translation pattern allows the translation of language, for example, translating a ticket or conversation from Japanese to English or vice-versa. The translation may be performed not only for text from a document however our system may read content from images and translate them in the target language.

In an exemplary embodiment, question and answer pattern answers private and general knowledge-based user queries, for example, answers general knowledge and private KB-type use cases. Specifically, the source data may be in any format such as, for example, but not limited to, PDF, word, CSV, excel, or text. It may transform the content into a machine-readable format. It may then be stored in the system for further questions and answers. This pattern provides the ability to filter the knowledge by metadata and then search for similarity checks. Further, this pattern has the ability to search within multiple indexes as per priority—for example if the information is not found in the SOP document, find the information in historical incidents. Furthermore, this pattern selects whether to return LLM public response—In some situations, due to legal requirements the system 102 may return data from custom knowledge documents.

In an exemplary embodiment, the classification pattern routes information to the correct location, for example, from the initial short description on a ticket the predict the correct team assignment. The classification of the contents when it is very high in volume could be challenging such as, for example, but not limited to, historical incidents. Sometimes the classifications may be required to be performed within a defined set of categories. The items require to be batched, sent to LLM, and then combined with the response. The batching is required to be efficient to overcome token limitations for the models.

Further, the processor 114 performs the plurality of actions corresponding to at least one of the plurality of solution patterns based on the received request. In particular, the processor 114 identifies the plurality of tasks associated with the plurality of solution patterns based on the received requirements. Thereafter, the processor 114 identifies the type of input parameters and the type of output parameters associated with the identified plurality of tasks based on the type of tasks, task properties, and sequence of execution of each task. Further, the processor 114 executes the plurality of tasks associated with the plurality of solution patterns based on the identified type of input parameters and the type of output parameters.

Furthermore, the processor 114 receives the solution pattern selected for performing the plurality of actions. The processor 114 is configured to pre-process the received request based on the solution pattern and generates the graphical user-interface (GUI) corresponding to the solution pattern. The processor 114 further determines the plurality of solution pattern properties associated with the solution pattern and performs the plurality of actions on the generated GUI based on the determined plurality of solution pattern properties.

In an exemplary embodiment, the data processing module 208 extracts the metadata from the received request and the plurality of actions based on the type of generative AI based solution to be generated. Specifically, the data processing module 208 extracts the plain text from the received request and the plurality of actions performed. Then, the data processing module 208 determines the metadata associated with the extracted plain text. The metadata may include use case properties, type of product requirements, content of the use case, domain category, document version information, user defined inputs, and additional requests from the user 108. Further, the data processing module 208 is configured to segment the extracted metadata into the plurality of data segments based on the plurality of solution patterns, and the request.

In an exemplary embodiment, the vector representation module 210 generates the vector representation of the plurality of data segments by embedding the plurality of data segments using the vector-based machine learning model. In particular, the vector representation module 210 is configured to embed the plurality of data segments using the vector-based machine learning model by merging the raw data of the received request with the extracted metadata and the vector value. Thereafter, the vector representation module 210 generates the vector representation of the embedded plurality of data segments. Further, the generated vector representation is stored in a corresponding vector database node.

In an exemplary embodiment, the vector representation module 210 generates the generative AI based solution corresponding to the received request based on the generated vector representation of the plurality of data segments. More specifically, the vector representation module 210 is configured to perform the similarity search for the generated vector representation by comparing the generated vector representation with the at least one vector representation of the pre-stored plurality of data segments. Further, the vector representation module 210 determines the similarity score for the generated vector representation based on the results of the similarity search and the priority level of the generated vector representation. The vector representation module 210 further generates the generative AI based solution corresponding to the received request based on the determined similarity score. The vector representation module 210 further generates the generative AI based solution based at least on mapping the generated vector representation with the at least one vector representation of the pre-stored plurality of data segments. Then the vector representation module 210 generates the embedded response including the mapped data segments and the part of the received request and determines whether the generated embedded response complies with the predefined organization rules. Further, the vector representation module 210 converts the generated embedded response to the large language model (LLM) readable file based on the results of determination. Thereafter, the vector representation module 210 generates the generative AI based solution.

It is to be noted that the LLMs are capable of learning to decode and generate human language. The LLMs are trained on massive datasets of text and code, and they may be used to perform a variety of tasks, including translation, writing, summarization, and text similarity check. Further, the LLMs may also be used to improve the way the system 102 search for information. By understanding the context of the query, the LLMs may provide more relevant and accurate results. Also, the LLMs are capable of summarizing content and generating content based on human understandable questions.

There are several Question and Answer based Chatbots being rapidly released by most of the leading companies. However, the answers are generated based on generic trained LLMs. They may not return information from company specific documents developed by users with several years of experience.

In an exemplary embodiment, the GenAI generating module 212 generates the generative AI based solution corresponding to the received request based on the generated vector representation of the plurality of data segments. More specifically, the GenAI generating module 212 performs the similarity search for the generated vector representation by comparing the generated vector representation with the at least one vector representation of the pre-stored plurality of data segments. Further, the GenAI generating module 212 determines the similarity score for the generated vector representation based on the results of the similarity search and the priority level of the generated vector representation. The GenAI generating module 212 further generates the generative AI based solution corresponding to the received request based on the determined similarity score. The GenAI generating module 212 generates the generative AI based solution based at least on mapping the generated vector representation with the at least one vector representation of the pre-stored plurality of data segments. Then the GenAI generating module 212 generates the embedded response including the mapped data segments and the part of the received request and determines whether the generated embedded response complies with the predefined organization rules. Further, the GenAI generating module 212 converts the generated embedded response to the large language model (LLM) readable file based on the results of the determination. Furthermore, the GenAI generating module 212 generates the generative AI based solution.

In addition, generating the generative AI based solution may include generating the answers to the at least one question from the user using the vector database; generating the answers to the automated voice mails; generating the summary of the automated voice calls; generating the document on the root cause analysis of the use case, generating the plurality of test cases from the plurality of user stories; generating explanation of the code, generating the test data for the test cases, co-relating the test cases with the plurality of user stories, analyzing the large relational data and recommending decisions, analyzing the diagrams in the architecture documents, generating documents from the chat history, generating the plurality of artificial intelligence (AI)-based insights from the indexed data and generating workflows for the use case. The workflows are generated using code scripts. The code scripts are generated using prompts.

In an exemplary embodiment, the validation module 214 validates the generative AI based solution using the at least one large language model (LLM). Specifically, the validation module 214 determines the intent of the received request from the user 108 by parsing the contents of the received request. The validation module 214 determines the LLM for validating the generative AI based solution based on the determined intent and by comparing the contents of the received request with the plurality of pre-stored LLM descriptions. Further, the validation module 214 determines the token usage limit of the determined LLM by accessing the LLM properties of the determined LLM. The generative AI based solution is routed to the determined LLM for validation. Thereafter, the validation module 214 applies trained large language models to the generative AI based solution based on the determined intent.

In addition, the validation module 214 determines the confidence score associated with the generative AI based solution based on the results of the application of the trained large language models. The validation module 214 updates the generative AI based solution based on the determined confidence score and generates the response to the received request. The response includes the updated generative AI based solution.

In an exemplary embodiment, the processor 114 continuously update the at least one large language model and the vector-based machine learning model with the validated generative AI based solution and the user feedback corresponding to the validated generative AI based solution. In an exemplary embodiment, the processor 114 outputs the generative AI based solution to the received request on the user interface.

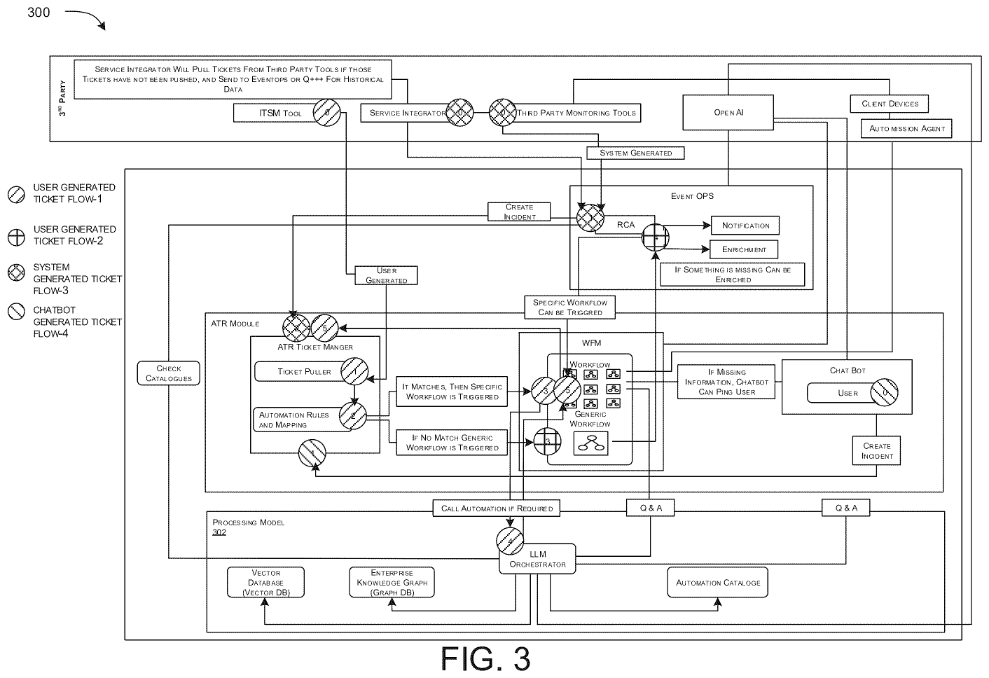

FIG. 3 illustrates implementation of the GenAI based solution for few automation use cases, in accordance with an embodiment of the present disclosure. For example, the automation use cases may include at least a user generated ticket flow-1, a user generated ticket flow-2, a system generated ticket flow-3, and a chatbot generated ticket flow-4.

In an example, for a user generated ticket-1, specific workflow triggered is shown below: A service now ticket is created by user, e.g., unable to log in, unable to place order. The system 102 (ATR Ticket Manager pulls the ticket. The system 102 ATR Ticket Manager looks for matches in automation rules and mapping. If matches, then a specific WFM workflow is triggered. If no matches, step 4 of user generated Ticket Generic Workflow is triggered. A LLM Orchestrator, calls (see, 302) automation if required. The WFM implements the workflow. Return to the system 102 Ticket Manager. Service ticket is updated.

In an example, for a user generated ticket-2 generic workflow triggered is shown below. A service now ticket is created by user, e.g., unable to log in, unable to place order. The system 102 ATR Ticket Manager pulls the ticket. The system 102 ATR Ticket manager looks for matches in automation rules and mapping. If no matches, then the generic workflow in WFM is triggered. If matches, step 4 of user generated ticket specific workflow is triggered. Further, pushed to the system 102 eventOps, where the RCA decides the next best action, check the catalogue for matching item. The workflow manager (WFM) may implement a specific workflow and return to the system 102 Ticket Manager. The service ticket may be updated.

In an example, for the system generated ticket 3, the workflow triggered is shown below: A third party monitoring Tools pushes to the system 102 eventOps. Service integrators may pull tickets that have not been pushed by Third Party Monitoring Tools and push those to the system 102 eventOps. The system 102 eventOps creates an incident. The system 102 ATR Ticket Manager pulls ticket. The remaining steps follow the User Generated Ticket Flow from Step 2.

In an example, for the chatbot generated ticket 4, the workflow triggered is shown below. A user initiates tickets via Chatbot. The ticket is pushed to the system 102 ATR Ticket Manager. The remaining steps follow the User Generated Ticket Flow from Step 1

It is to be noted that the sequence of each step associated with the user generated ticket flow-1, the user generated ticket flow-2, the system generated ticket flow-3, and the chatbot generated ticket flow-4 are exemplary depicted using the same reference numbers in FIG. 3.

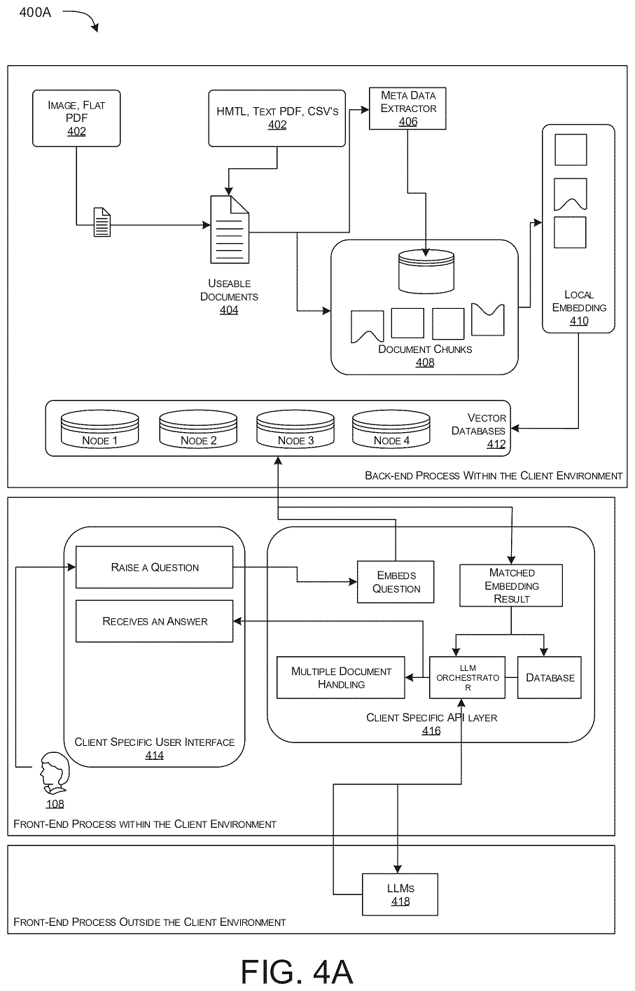

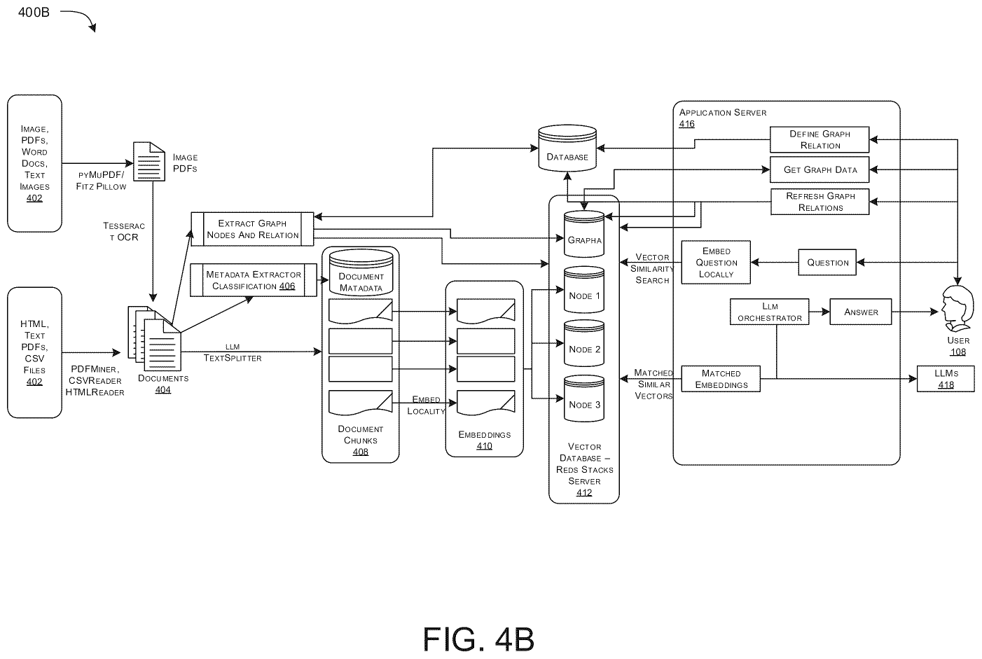

Referring to FIGS. 4A and 4B in conjunction with FIG. 3, a block diagram representation of a high-level architecture 400 implementing the GenAI based solution for the use cases is shown, in accordance with an embodiment of the present disclosure.

At the backend, non-text-based files 402 are converted into a PDF format using PDF conversion tools. Further, the PDF format and text-based files are converted into usable and searchable document structures 404. The architecture 400 includes a data pre-processing component (not shown in Figures) to extract plain text from several types of documents including HTML, CSV, Text PDF, Image PDF, and Images containing text such as, for example, but not limited to, scanned documents. Further, the metadata from the usable and searchable document structures 404 is extracted using a metadata extractor 406. The document 404 is separated into small files (e.g., 1000-character blocks) that are referred to as document chunks 408. The architecture 400 may include a document chunker (not shown in Figures) to break the extracted texts into smaller chunks. The chunks store the original document source and page numbers. Further, the document chunks 408 are embedded locally using an opensource model (e.g., a hugging face opensource model) by adding the raw data with the document metadata and a numerical value called as a vector (see, 410). Along with the embeddings of the individual document chunks, the metadata about the document such as, for example, but not limited to, document name, page number, and the like are also extracted for enriching answers. The vectors are used to enable faster searching where the search compares vectors rather than characters. The embedding is performed locally without requiring to sending the documents over the internet. All the locally embedded documents are stored into a vector database 412. The vector database 412 helps by searching the similar and relevant chunks based on cosine-similarity of the vectors. For example, the vector database 412 may be Milvus.

At the front end, the user 108 may raise a question through a client interface. The question is locally embedded following the chunk and vector approach as above. Typically, the architecture 400 may include a question embedding component (not shown in Figures) to convert questions into vector format such that it may be searched against document custom knowledge repository (or the vector database 412). Further, embedded vectors are searched (i.e., the similarity search) within the vector database 412 to find possible matches. Thereafter, matched results are returned into an embedded result file including the matched chunk and the question. In this case, the questions may be generic and similar answers may be found in multiple documents. In this scenario, a multiple document resolver of the architecture 400 may form a question dynamically to get feedback if the user 108 wants to select among them or provide best possible answer. Furthermore, the question and result are converted to a LLM readable file using LLM Orchestrator associated with client specific API layer 416. The LLM Orchestrator is a framework developed for interacting with LLMs 418 and answer a chain of questions. The LLM Orchestrator component takes the embedded questions and matched question chunks, connects with the LLMs 418 containing trained data, understands the intent from the question and returns best possible result from matched chunks. The data (i.e., the training data) is stored in a historic database (or the LLMs 418) with previously asked questions and answers to measure the accuracy of the responses. The matched text results and the initial question are passed to the LLMs 418 by using the opensource AI and a private LLM. The LLMs 418 send back the curated answers based on the results found. In other words, an answering component (not shown in Figures) of the architecture 400, associates the result with questions, adds the original document information with the answer and returns to the user 108. Further, the LLM Orchestrator converts back the results into a user readable format and rendered to the user 108 via the user interface 414 as a single result or if multiple files are received through the multiple document resolver. In addition, based on the predefined rules if the indexed document has an inherent hierarchical nature, it may be represented as graphs.

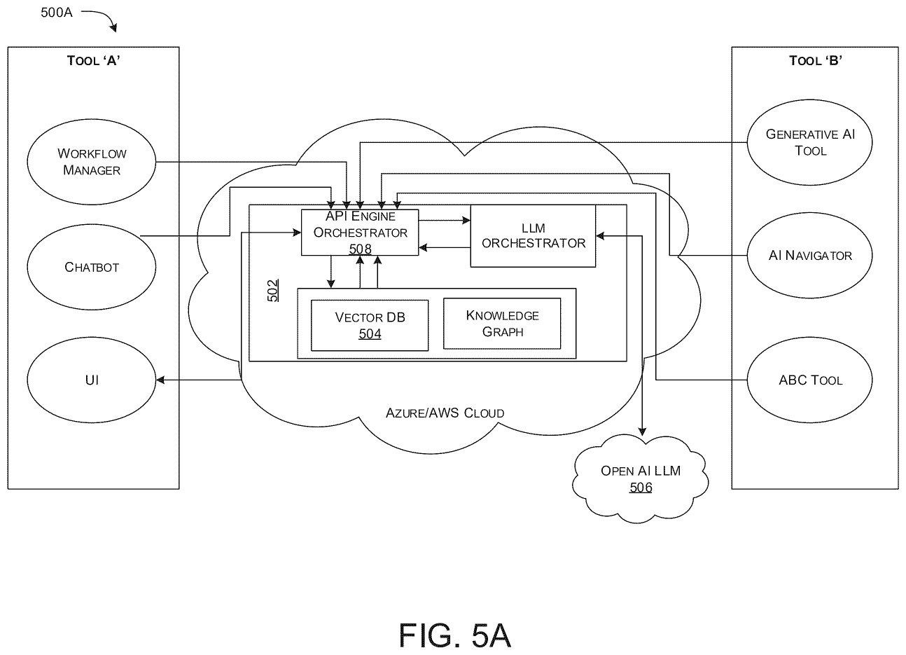

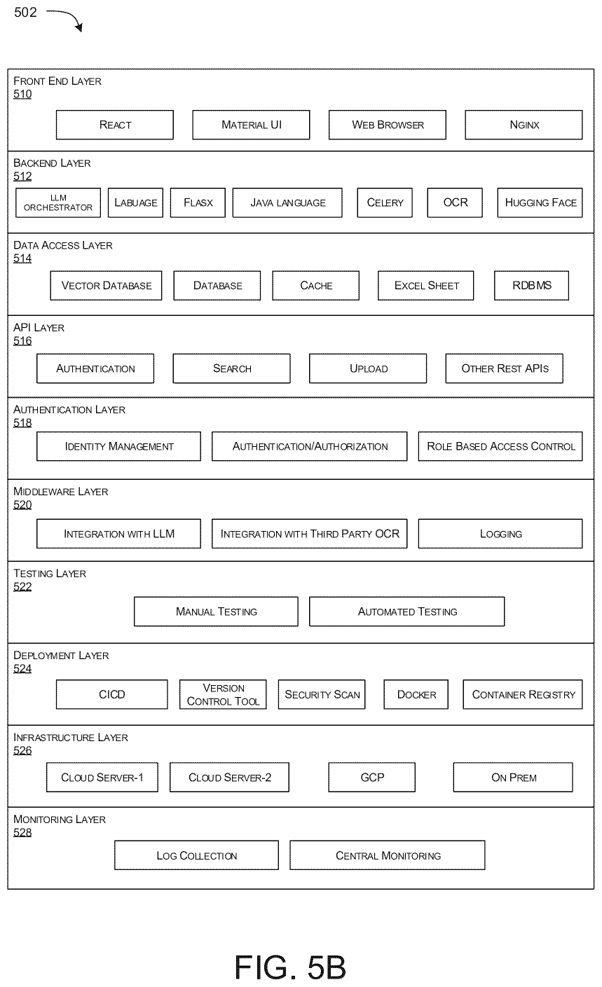

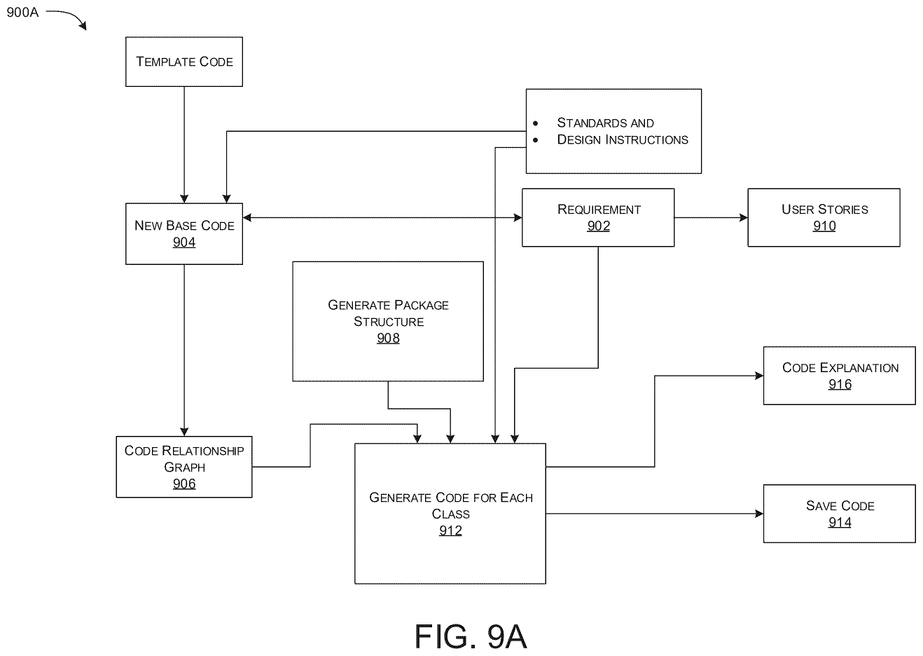

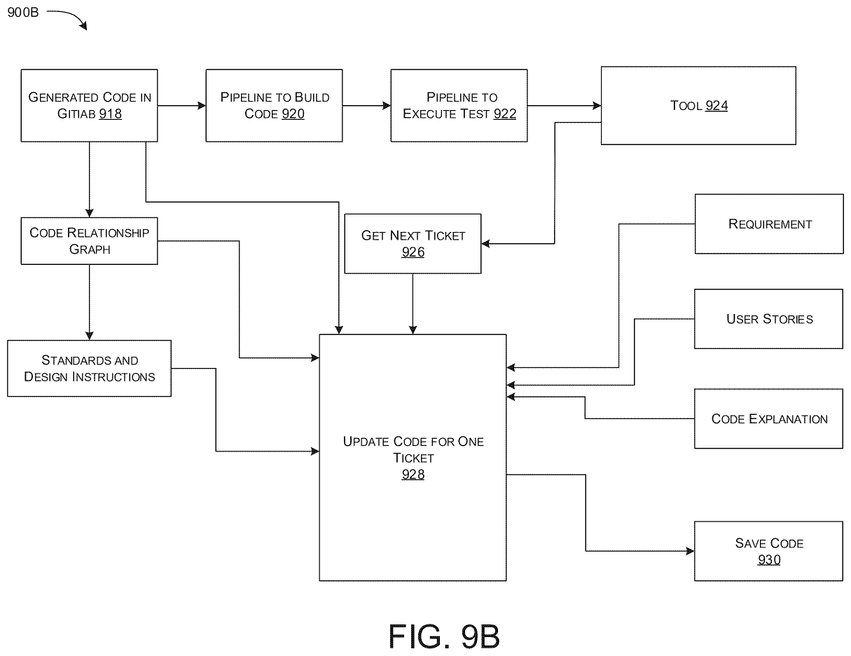

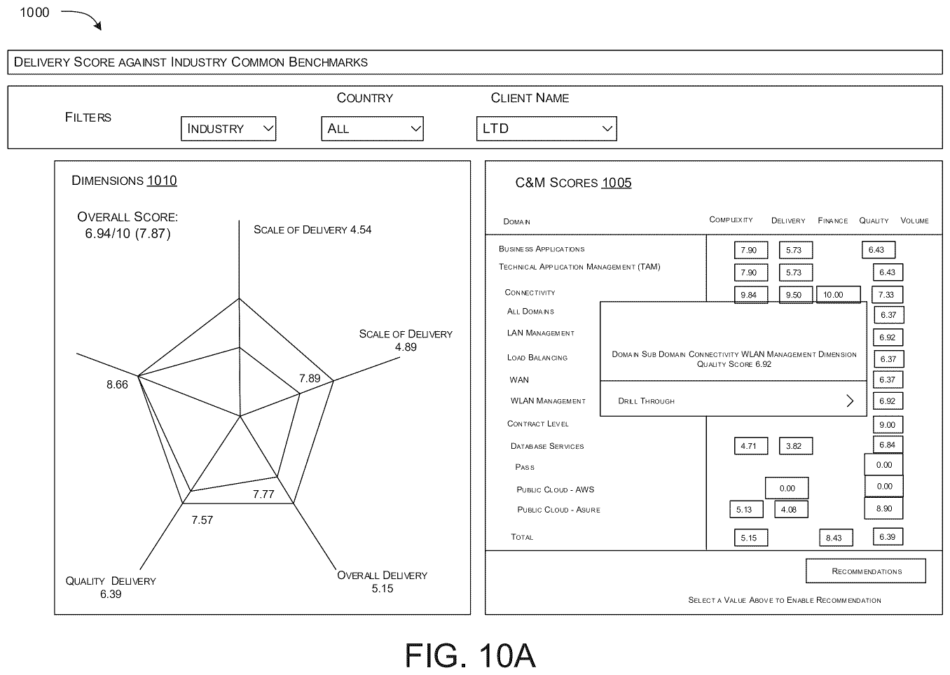

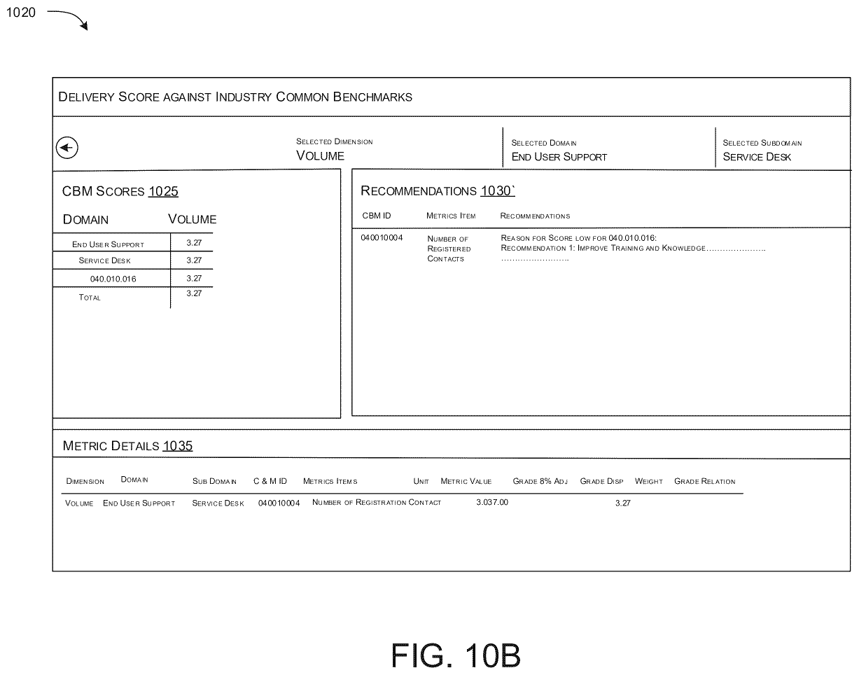

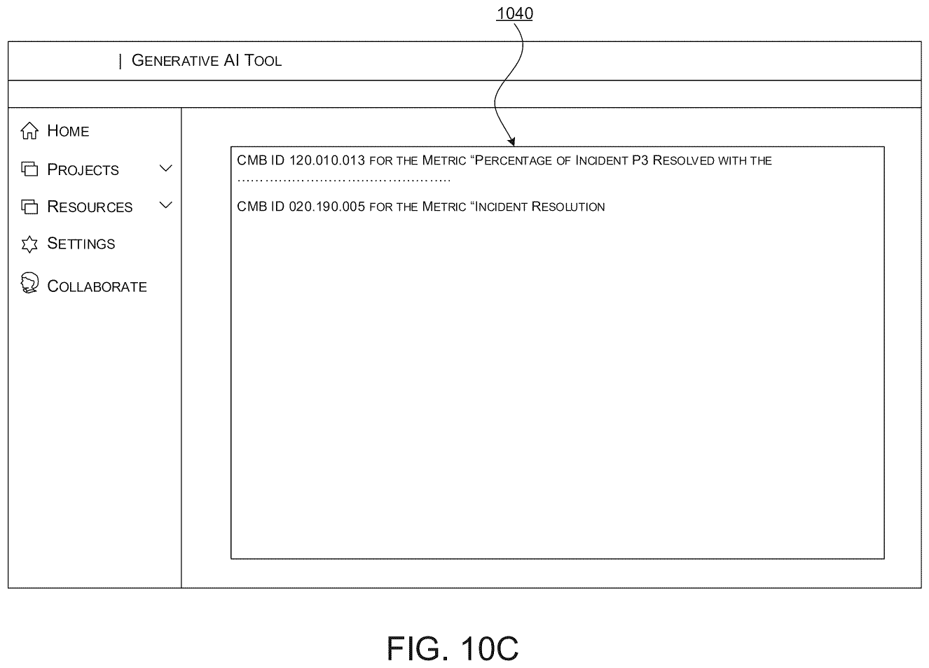

Referring to FIG. 5A in conjunction with FIGS. 4A and 4B, a simplified block diagram representation 500 depicting the integration of a processing model with other applications using application programming interfaces (API) is shown. Typically, multiple tools (tools ‘A’ and tools ‘B’) are integrated with a processing model 502 to perform one or more operations such as storing the documents on the vector database, asking questions, filtering the parts of the document, and getting answers from Open AI. The user 108 may upload the documents into the model 502. The model 502 pre-processes the documents to obtain usable and searchable documents. Thereafter, the model 502 extracts texts from the documents and the texts are chunked and embedded. Then the model 502 stores the document chunks along with the metadata in a vector database 504. The user 108 asks a question about the stored documents. The question is embedded, and similar chunks are retrieved from the vector database 504. The similar chunks are then sent to LLM 506 for fine-tuned answers. The answer is then checked against the matched chunks to understand the source of the answer. The answer is then sent back to the user 108. Further, parameters considered to compare the vector database selections are listed below: adaptability (referring to ease of use, scalability, high availability, speed, and cost), features (referring to ability to support knowledge graphs, ability to support response cache, ability to support application page cache, ability to search within the vector database, ability to search based on metadata, ability to tune performance, migration support from other vector databases, languages supported to interact with vector database, ability to store images, ability to search by images). a product maturity (referring to community support, age of the product), deployment and maintenance (referring to take backups of data, restore backed-up data, support for docker container, deployment support through Cloud, Deployment support through a cloud infrastructure, and Hardware requirement), supporting multiple file types (referring to index the content, first the content is parsed from the documents. Then tables and images are extracted during parsing. Ensure already structures available in the document is not lost, such that the answer may be more meaningful. The Excel sheet documents are required to be stored as a key value pair such that they could be queried and filtered efficiently), handling multiple data sources (referring to ability to implement a fallback mechanism, where if the answer is not found in the top priority source, it needs to be returned from the default source. Example: if the answer is not found in the SOP document, then return the answer from historical incident resolution comments), restricting answer from LLM (for example, there may be a few use cases where there is no requirement to return any generic answer from LLM if no answer is found from the knowledge base. This is performed through prompt engineering), a return response from Knowledge Repository (for example there are a few situations (e.g., data is too sensitive) where there is a requirement to return a similarity search from vector database. For example, identify the category of incident based on historical incidents. This is performed by performing a vector similarity search and return score), handling token limit (for example, it is well known that LLM supports a certain limit of tokens. To handle this, an efficient tokenization mechanism is used to pre-calculate the token usage to avoid token limit exceeded error), handling big files (referring to Indexing big files may take more time and API may timeout. To avoid this, design the upload APIs asynchronous with an option to check status, and then batch indexing rows from the large excel sheet), a search and display the content on a chatbot UI and displaying the image from the document along with text was a requirement, (images are extracted from document and provided with a reference to the image in the text. Hence, a separate API is provided to display the image), challenges in code generation (referring to the challenges in code generation is explained in detail with references to FIGS. 9A and 9B) generation of relation from the indexed data), the generation of hierarchy data and filling up the gaps in hierarchy, analyzing data from an excel sheet, and to provide recommendations. Further, providing recommendations is explained in detail with references to FIGS. 10A to 10C.

The interaction with the LLM 506 and the user 108 is managed through an API Layer hosted and managed by an API engine orchestrator 508. This ensures best practices of using LLM APIs, security and centralized control of LLM usage. The API Layer contains the below initial set of APIs which may help implement various use cases using LLM and organization documents. The APIs are exemplarily shown below in Table 1.

TABLE 1

| API URL | | |
|---|---|---|
| Authentication | | |
| Base<Auth>: /identity- | | |
| management/api/v1/auth | | |
| ACNOpenAI | | |
| Base<ACNOpenAI>: /api/ | | |
| v2/acnopenai | Description | Use Cases |
| Security (Used in all APIs) | The tool provides an | While summarizing a |
| | option to scrub | confidential document the |
| | personal data for | system 102need to ensure |
| | sensitive and | no sensitive information is |
| | confidential documents | sent to LLM. To avoid |
| | before sending content | changing the meaning of |
| | to LLM. The original | the sentence the personal |
| | information is replaced | data is anonymized rather |
| | with anonymous data | than masking or removing. |
| | while sending prompt | |
| | to LLM. The original | |
| | information is replaced | |
| | back once the answer | |
| | is retrieved from LLM | |
| <Auth>/short-token | Used to create API | Short lived authentication |
| | authentication tokens. | token to ensure only |
| | This needs to be used | authorized users may |
| | when accessing | access the APIs. The |
| | ACNOpenAI APIs. | roles assigned to the |
| | This also assigns roles | users ensure authorization |
| | to the authenticated | to APIs and contents the |
| | user. | users may search on. |
| <ACNOpenAI>/search | Used to search within | Knowledge Repository |
| | organization | Search |
| | documents. Using | Frequently asked |
| | vector search first | questions |
| | similar chunks are | Finding products |
| | retrieved and then | Finding attributes related |
| | using OpenAI fine- | to questions. |
| | tuned answer returned. | |
| <ACNOpenAI>/chat | Used to start a | Context based search |
| | conversational search | where the previous |
| | within organizational | question and answers |
| | document. | remembered. |
| | | Finding IT assets |
| | | corresponding to Retail or |
| | | Finance industry. Multiple |
| | | conversation may need to |
| | | happen before coming to |
| | | the result |
| <ACNOpenAI>/searchvectors | Used to see what is | Generate test cases for |
| | indexed in vector | the already existing Active |
| | database. This also | use cases. The system |
| | allows to filter the | 102 may need to first see |
| | content based on | what the Active use cases |
| | vector search query | are. |
| | | The search result may |
| | | then be used for further |
| | | processing. |
| <ACNOpenAI>/searchandgenerate | Used to generate new | When the input data is |
| | contents based on | long and need to ensure |
| | existing content. First | all input data is processed, |
| | the input data is | as there are limitation on |
| | retrieved through a | number of tokens may be |
| | vector search then the | sent in single request to |
| | LLM prompts are built | LLM, the system 102need |
| | dynamically based on | a mechanism to batch the |
| | prompt templates. | request. This API allows to |
| | Users may select | filter the input batch the |
| | prompt objective, | request, dynamically build |
| | prompt prefix, prompt | the prompt and then |
| | templates and prompt | combine the response. |
| | suffix. | Example to generate test |
| | | cases and test data for |
| | | already existing user |
| | | stories. |
| | | Correlate already existing |
| | | use cases and test cases. |
| <ACNOpenAI>/searchandsummarise | Summarize the content | While preparing RFP |
| | of a document or | response the system |
| | search result. | 102first need to |
| | | understand various |
| | | answers based on the |
| | | RFP response templates. |
| | | This API helps search |
| | | contents from document |
| | | and summarize, |
| | | as there are limitation on |
| | | tokens. |
| <ACNOpenAI>/upload | This is the main API | Upload organization |
| | that manages | documents so that it may |
| | uploading documents | be searched. |
| | to the system, pre- | The images from the |
| | processing the | document are extracted |
| | content, and indexing it | and using OCR the text |
| | into vector database. It | from the images are |
| | may accept documents | extracted. |
| | in various formats like | |
| | text, csv, word, word | |
| | documents with | |
| | images, excel, pdf, pdf | |
| | with images, ppt, rft, | |
| | html, and the like. | |
| | The system 102may | |
| | also upload a zip file | |
| | containing multiple | |
| | documents. | |
| | The upload API works | |
| | asynchronously. It | |
| | returns a task id for | |
| | status check. | |
| <ACNOpenAI>/uploadstatus/ | Used to check the | Check the upload status of |
| <type>/<value> | upload status for a | a file. |
| | task id. | Check the upload status of |
| | Status for individual | zip file. |
| | files within a zip file | |
| | may be seen. | |
| <ACNOpenAI>/searchtitle | Sometimes the system | While reading an API |
| | 102need to search | specification the code and |
| | only within particular | explanation could be in |
| | type of contents like | different format. This API |
| | searching only | helps to search only within |
| | contents written in a | code or explanation. |
| | specific font or format. | |
| <ACNOpenAI>/uploadtitle | This API allows | Ignore the page number, |
| | indexing only part of | version history, table part |
| | the document that | from a document and |
| | matches a particular | index only description |
| | format or position in | sections. |
| | the document. | Index only code written in |
| | | specific fonts. |
| <ACNOpenAI>/clearindex | Used to clear indexed | Clear the wrongly indexed |
| | content from vector | document content. |
| | database for a | |
| | document. | |
| <ACNOpenAI>/clearentireindex | Used to clear entire | Clear the entire index to |
| | index. | reindex documents due to |
| | | some software changes or |
| | | requirements. |
| <ACNOpenAI>/generate | Used to generate | Provide me a python code |
| | content based on a | for uploading a document. |
| | question. Not | |
| | necessarily based on | |
| | any document | |
| | however generic | |
| | answer may be | |
| | returned from LLM. | |
| <ACNOpenAI>/chatcompletion | Used to start a | Provide me the use cases |
| | conversational search | related to payment |
| | and generate content | gateway with use case id |
| | based on | Generate the test cases |
| | organizational | for the use case |
| | document. It may be | USECASE-001. |
| | session specific where | |
| | user may reset the | |
| | session if they want. | |
| <ACNOpenAI>/docgen | The output of the | Select the chatcompletion |
| | chatcompletion APIs | answers and generate the |
| | may be saved and | output in a word document |
| | latet this API may be | following a template. |
| | used to generate | |
| | document from this | |
| | chat messages. | |
| <ACNOpenAI>/download/ | This API is used to | Download and display the |
| <docname>/<imagename> | download the images | images in chatbot along |
| | extracted from | with the response to the |
| | uploaded word | chat question. |
| | document or PPT or | |
| | PDF. Image URLs are | |
| | generated during | |
| | parsing the document. | |
| <ACNOpenAI>/listdocs/ | API used to display list | May be used to verify if a |
| <index_name> | of documents already | particular document is |
| | indexed under an | already indexed and what |
| | index. | is the chunk count which |
| | | represents number of |
| | | paragraphs |
| | | (approximately) |
| <ACNOpenAI>/diagram/ | This API may be used | Download the draw.io |
| <modulename>/<filename> | to download Draw.IO | diagram for EC2 instance- |
| | compatible diagrams | based website |
| | where the content is | architecture. |
| | uploaded into the | |
| | system as a xml | |
| <ACNOpenAI>/listindexes | API used to display list | May be used to |
| | of indexes already | understand how many |
| | exists in the vector | indexes already created in |
| | database. | vector DB |
| <ACNOpenAI>/doccontent/ | API used to return | Return indexed content |
| <index>/<filename> | indexed vector | from <index_name> for |
| | database content for a | the document |
| | particular document. | <doc_name> |
| <ACNOpenAI>/api/v2/ | The output of | Review the saved chat |
| acnopenai/savedchats | chatcompletion API | history and decide what |
| | are already saved by | may go into an RFP |
| | default per chat | response to be generated |
| | session. This API may | |
| | retrieve the saved chat | |
| | outputs. | |
| <ACNOpenAI>/listgraphs | API used to display list | May be used to |
| | of graphs already | understand how many |
| | exists in the graph | graphs already created in |
| | database. | graph database |
| <ACNOpenAI>/graphdata/ | Returns the graph data | Return the graph data for |
| <graph_name>/ | in a json format | retail industry hierarchy |
| <param_name>/<param_{—} | | |
| value> | | |
| <ACNOpenAI>/graphattr/ | This API could be the | On click of a graph node |
| <graph_name>/<node_id>/ | onclick handler for the | return further details about |
| <attribute> | graph | the node |
| <ACNOpenAI>/treedata/ | Returns the tree | Return the tree formatted |
| <index>/<file_name> | formatted data in a | json output for IT services |
| | json format | domain, subdomain, and |
| | | benchmark metrics |
| /savedata/<string:index>/ | Upload json data in the | Upload JSON data, store |
| embedby/<string:embedby> | Vector DB JSON store | in Vector DB JSON store, |
| | and index the data | Index the data and embed |
| | | by selected fields |
| <ACNOpenAI>/api/v2/ | Allow filtering on | Filter on metadata and |
| acnopenai/searchdata | metadata and perform | perform similarity search |
| | similarity search on | on selected fields within |
| | selected fields | an index |

FIG. 5B is a simplified block diagram representation depicting a technology stack of the model 502, in accordance with an embodiment of the present disclosure. The model 502 is a microservice-based, containerized, web application with a React frontend and Python® Flask backend using LLM based API interactions, Vector Database, and HuggingFace offline models as explained above.

In particular, the model 502 includes a frontend layer 510, a backend layer 512, a data access layer 514, an API layer 516, an authentication layer 518, a middleware layer 520, a testing layer 522, a deployment layer 524, an infrastructure layer 526, and a monitoring layer 528.

The front-end layer 510 may include front-end tools (as shown in FIG. 5B) that are configured for generating the user interface (UI) and user experience (UX). The backend layer 512 may include backend tools that are configured for processing data, performing computations, and interacting with databases, servers, and other external resources. The data access layer 514 may include various sources of fetching and storing data are implemented. In particular, the data access layer 514 may include various databases, repositories, or libraries (as shown in FIG. 5B) for storing, retrieving, and managing data. The API layer 516 may include exposing RestFul APIs for other consumers to consume. The authentication layer 518—performs authentication and authorization. The Middleware Layer 520—facilitates integration with third party APIs, LLM integration, OCR tool integration.

The testing layer 522—performs automated and manual testing to ensure quality. The deployment layer 524—performs automated deployment, CI/CD Tools integration, and security scans. The infrastructure layer 526 acts as a hosting layer on cloud or on premise. The monitoring layer 528—collects logs from application and monitoring.

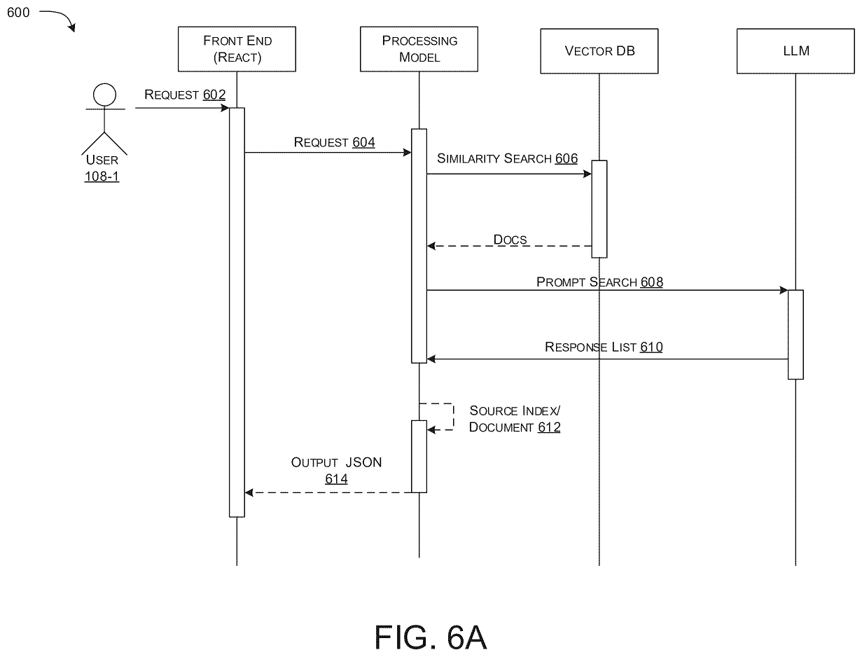

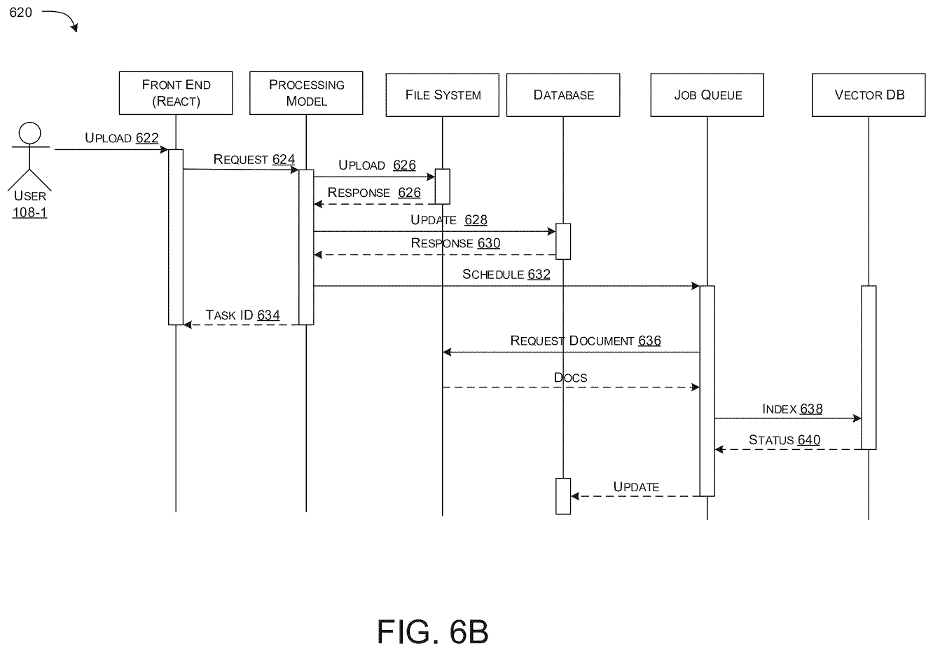

FIG. 6A illustrates a process flow 600 depicting a document search workflow, in accordance with an embodiment of the present disclosure. The process flow 600 starts at 602.

At 602, a user (e.g., the user 108-1) sends a request to the system 102. The request may be a question. In particular, the user 108-1 may provide inputs related to the question in a user interface rendered on the user device (e.g., the user device 106-1). The question (or the request) is forwarded to a processing model from the front end (see, 604).

At 606, the question is embedded, and similar chunks are retrieved from a vector database (exemplarily represented as ‘Vector DB’).

At 608, the similar chunks are then sent to LLM (or Agile OpenAI) for fine-tuned answer. In other words, the model prompts a search to the OpenAI model to fetch a fine-tuned answer.

At 610, the OpenAI model transmits a response list including the answer for the request.

At 612, the answer is then checked against the matched chunks to understand the source of the answer.

At 614, the answer is sent back to the user 108-1.

FIG. 6B illustrates a process flow 620 depicting a document uploading workflow, in accordance with an embodiment of the present disclosure. The process flow 620 starts at 622.

At 622, the user 108-1 uploads the documents. In particular, the user 108-1 may upload the documents in a user interface rendered on the user device (e.g., the user device 106-1). The documents are forwarded as input (or as a request) to the model from the front-end interface (see, 624). Thus, the documents are uploaded into the model.

At 626, the model uploads the documents to a file system. Further, a response of uploading the documents into the file system is transmitted to the model by the file system (see, 628).

At 630, the model updates the status into a database.

At 632, the model schedules for processing the documents. In this scenario, a track ID is created and rendered on the user interface for allowing the user 108-1 to view the track ID of the document processing (see, 634).

At 636, the documents are fetched from the file system. Further, the documents are preprocessed to make it easily searchable, the texts are extracted from the documents, and the texts are chunked and batched. Furthermore, each batch is sent to a queue for processing. The queue consumer consumes the task, embeds the chunks.

At 638, the document chunks along with metadata are stored in the vector database.

At 640, the status is updated back in the database.

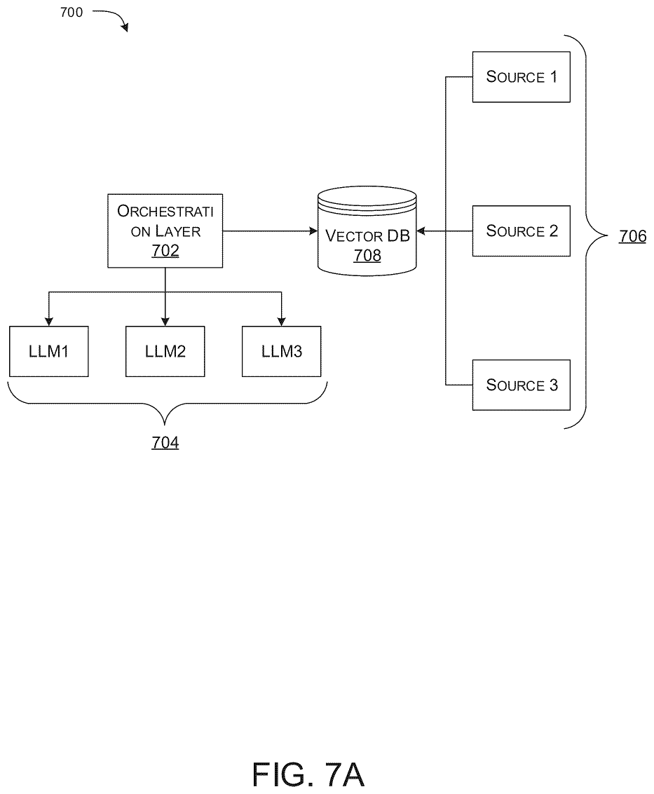

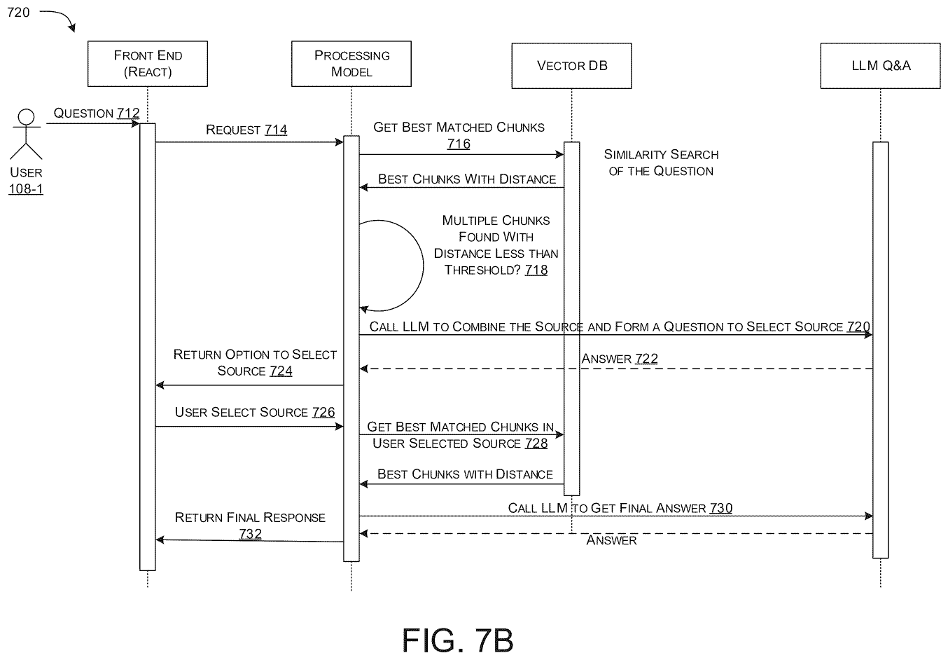

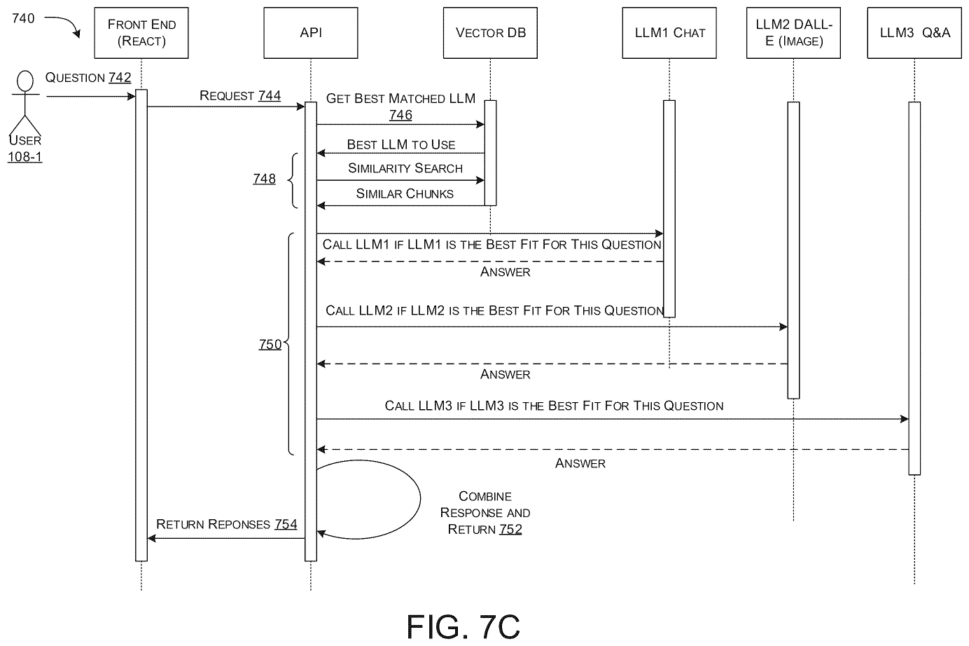

FIG. 7A illustrates a simplified block diagram representation of an orchestration model 700, in accordance with an embodiment of the present disclosure. An orchestration layer 702 helps to make the API layers independent of LLMs 704 and data sources 706. Sometimes the users' (e.g., the user 108-1) questions may be very generic and the answer may be related to multiple documents. The orchestration layer 702 helps to identify such situation where asks the user 108-1 about which sources the user 108-1 is referring to via a vector database 708. The one or more operations performed in case of multiple documents are explained in detail with reference to FIGS. 7B and 7C.

FIG. 7B illustrates a process flow 710 depicting a workflow for resolving multiple sources, in accordance with an embodiment of the present disclosure. The process flow 710 starts at 712.

At 712, the user 108-1 asks a question by providing inputs on a user interface rendered by the front-end interface of the system 102.

At 714, the front-end interface creates a request by appending the question of the user 108-1 and transmits it to the model.

At 716, the model embeds the question and similar chunks retrieved from the vector database.

At 718, the model checks if the vector distance for the multiple chunks is less than a threshold.

At 720, the model identify the sources of the chunks and ask LLM to form a question to understand the user 108-1 intent. At 722, the model receives the answer from the LLM. At 724, options are provided to the user 108-1 to select the sources based on the answer from the LLM. At 726, the user 108-1 submits the choice.

At 728, the question is embedded, and similar chunks are retrieved from the vector database only for the selected source.

At 730, the similar chunks are then sent to the LLM for fine-tuned answer.

At 732, the answer is sent back to the user 108-1.

Through frameworks such as, for example, but not limited to, LLM Orchestrator various LLM connections may be made configurable. The orchestration layer may take the decision to use the best LLM based on the use cases. Further, different LLMs has different specialties. To implement automation, use cases, as the user enquiries may be of various types, it may be required to use the LLMs dynamically based on the user queries.

FIG. 7C illustrates a process flow 740 depicting interaction of API layers with multiple LLMs, in accordance with an embodiment of the present disclosure. The process flow 740 starts at 742.

At 742, the user 108-1 asks a question by providing inputs on a user interface rendered by the front-end interface of the system 102.

At 744, the front-end interface creates a request by appending the question of the user 108-1 and transmits it to the model.

At 746, the question is compared within a catalogue of LLM descriptions to understand which LLM fits for the question better.

At 748, the question is embedded, and similar chunks are retrieved from the vector database.

At 750, the similar chunks are then sent to the best fit LLM for fine-tuned answer. The answer is then checked against the matched chunks to understand the source of the answer.

At 752, responses from different LLMs are combined to create a response for the request raised by the user 108-1.

At 754, the response is sent to the user 108-1.

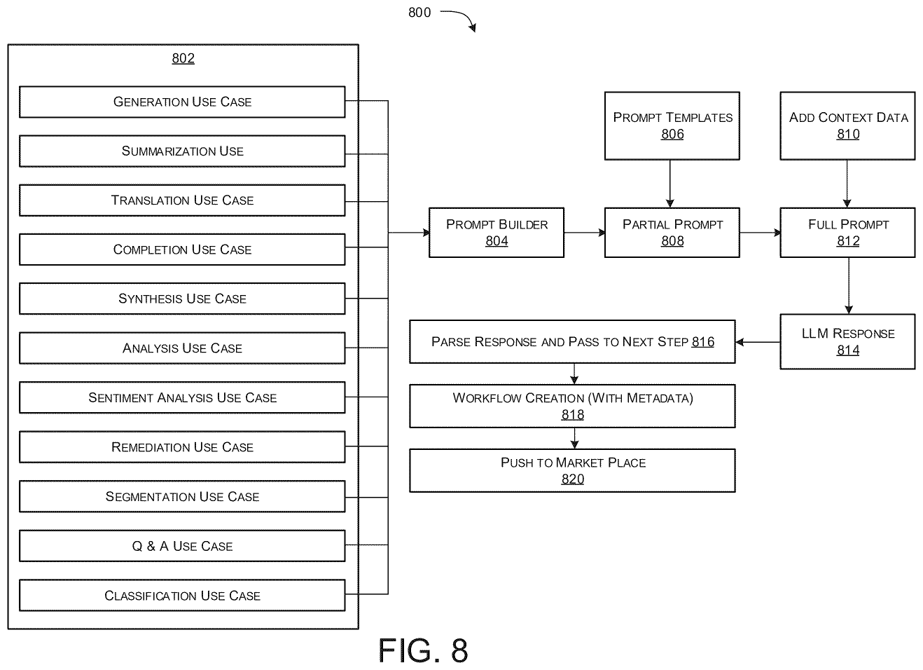

FIG. 8 illustrates a prompt builder workflow 800, in accordance with an embodiment of the present disclosure. The workflow prompt builder 800 provides UI components with drag and drop capability to implement the workflow tasks. Example, if the user 108-1 wants to summarize a document it allows to drag and drop summarize components, then allows to select input data sources and output targets.

A pattern selector 802 allows the user 108-1 to select the pattern based on use case while creating a GenAI based workflow. The patterns may include the generation pattern, the completion pattern, the synthesis pattern, the analysis pattern, the summarization pattern, the sentiment analysis pattern, the remediation pattern, the segmentation pattern, the translation pattern, the question-and-answer pattern, and the classification pattern. The user 108-1 may drag and drop the pattern component in the workflow builder main area. Subsequent properties may require to be supplied based on pattern selected.

A prompt builder 804: Once the UI components are created and saved, the prompt builder 804 component may start building the expanded full prompt based on the pattern selected and the context data.

Prompt templates 806: Further, a set of pre-built prompt templates 806 corresponding to each of the patterns are available. There could be multiple templates for each pattern based on additional properties selected. It may contain a placeholder for the context specific data to be added in the prompt.

Partial Prompt 808: The selected prompt from the prompt template based on pattern and the properties selected.

Add Context Data 810: The logic of how the source data may be fetched and filtered based on the properties is selected.

Full Prompt 812: Full prompt may be formed by adding the context specific data in the partial template.

LLM Response 814: Once the workflow 800 is executed it may form the full prompt and make an LLM call to get the response.

Parse Response and pass to next step 816: Once the LLM response is received, this component may parse the response, populate the output parameters, fill up the input parameters for next step and initiate next step execution. The workflow may contain multiple steps to implement a particular business process.

Workflow Creation with Metadata 818: In this step the workflow creation API is called using the LLM response and the parameters. Metadata is generated about the workflow such that the workflows are searchable from the automation catalogue.

Push to Marketplace 820: Once the workflow is generated along with the metadata, it is pushed to workflow marketplace such that it may be reused by other use cases.

FIG. 9A illustrates a flowchart depicting a method 900 for generating a code, in accordance with an embodiment of the present disclosure.

At 902, the user 108-1 provides input related to requirement (or uploads application architecture document).

At 904, a base code is generated. In particular, the base code is generated by selecting a template code. Thereafter, a copy project script is auto generated based on README file and dev standards. Further, the copy project script is executed to generate the base code.

At 906, a code relationship graph is generated based on the template code.

At 908, a package structure is generated. Specifically, to generate the package structure a copy project script is auto generated. A base package structure from the template using README is determined. Then, modify the package structure and class names based on the requirement.

At 910, user stories are generated in JIIRA.

At 912, the code is generated for each class. Typically, a prompt is generated using the requirement, the code relationship graph, Dev standards, the package structure and chat history. Upon generating the prompt, the code is generated for each class.

At 914, the generated code is saved. The code is extracted from LLM response and is saved in package. Then code may check in into Gitlab.

At 916, a code explanation is generated.

However, there are many challenges in code generation. Some of the challenges of the code generation are required to follow a template as the base code to carry best, normally README file explains how to use the template to create a new module, new requirements come in the form of an application architecture document, the app arch document talks about new requirements, there is normally no detailed design document or explanation available for template code. It is hard to identify which part of the code may be impacted by the application architecture document. Further, the challenges may include a need to identify a module name or class name for the newly generated code, the newly generated module required to be placed under a proper package structure in line with the template project, here may be multiple code modules that required to be generated in sequence, each module is required to maintain the relative position and maintain package structure, the generated code should be based on application architecture document, where no duplication of code exists, at the same time no information may be missed from the application architecture document, the generated code may be based on the framework defined in the template.

In some examples, the generated code module should follow the same naming convention as the template code, hard to implement business logic along with maintaining relation with other related components, most of the time generated code may have missing business logic, ability to fetch the application architecture documents from various sources such as, for example, share point, confluence or chatbot, generated code may not be based on framework used in template if the framework is recently released, the generated code may not compile as a whole, as the generated code is based on couple years back trained data, it may include vulnerabilities, once the code grow it is hard to maintain context and generate code for new requirements. Sometimes it may be required to update a line of code without changing anything else, need to generate code based on a particular language defined in the template. Implement business logic along with maintaining relation with other related components. Any additional packages required by the new code needs to be added to the package requirements file. The generated code needs to follow development standards. The ambiguous requirements may require attention from human developers. Limitation in context length allowed in LLM API calls. Randomness in the LLM response, it is hard to identify code part from the response. There could be multiple languages used in the code such as, for example, but not limited to, typescript and java scripts. Best practices such as authentication, logging, unit test cases need to be followed. There could be change requests which require only modification of related code. The challenges in generating the code may be resolved by performing one or more operations as explained with reference to FIG. 9B.

FIG. 9B illustrates a flowchart depicting a method for incrementally fixing issues in generating the code, in accordance with an embodiment of the present disclosure. At 918, the code is generated in for example, Gitlab. At 920, a devops pipeline is implemented to build the code. At 922, a test is executed using the devops pipeline. At 924, a tool (such as for example, but not limited to a JIIRA tool) is used to raise JIIRA tickets with compilation issues raised from step 920 or test failure in step 922. At 926, the JIIRA ticket is generated. At 928, the code is updated based on the JIIRA ticket. As shown, the related code from the code explanation and Gitlab is acquired. Further, a prompt is created using the requirement, the user stories, the related code, Dev standards, and chat history. Thereafter, the code is updated based on the prompt results.

At 930, the updated code is saved. The updated code is extracted from LLM response, and the code is updated in class. Then updated code may check in into Gitlab.

FIG. 10A illustrates an example representation of a user interface (UI) 1000 depicting delivery scores as a result of document analysis, in accordance with an embodiment of the present disclosure. The UI 1000 is depicted to include a CBM score section 1005 depicting scores for each of the domains and an overall delivery score 1010. For example, the overall delivery score is depicted to be 6.94/10.

FIG. 10B illustrates an example representation of a user interface (UI) 1020 depicting scores related to a volume parameter, in accordance with an embodiment of the present disclosure. The UI 1020 is depicted to include a parameter selected for viewing the score. The parameter selected is ‘Volume’. Further, the UI 1020 depicts domain and subdomain selected. For example, the domain and subdomain are depicted as End user report and service desk, respectively. The UI 1020 further depicts a CBM score section 1025 depicting CBM scores for the domain and subdomain. Further, the UI 1020 depicts a recommendation section 1030 and a metric details section 1035. The recommendation section 1030 includes a list of recommendations to improve the CBM scores. The metric details section 1035 depicts the metric value of the domain and subdomain. In an embodiment, the data may also be queried through a chatbot interface (as shown in FIG. 10C).

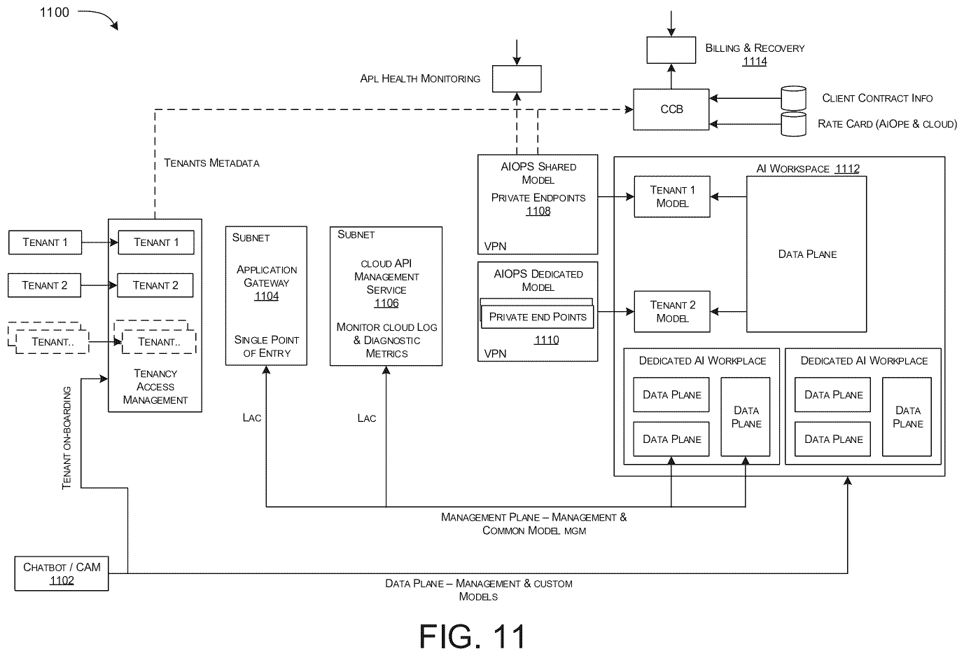

FIG. 11 illustrates a simplified block diagram representation of a high-level architecture to implement multiple clients GenAI solutions in a cloud environment, in accordance with an embodiment of the present disclosure.

As shown, AiOps applications are accessing the Gen-AI service, through a common chatbot framework 1102 or a prompt engineered framework centralized tenant management services.

Further, cloud application gateway 1104 provides a single/centralized point of entry to cloud Open-AI Service. Leveraged to create subdomain for multiple tenant services and create respective backend pools for the Gen-AI services configure multi-site listeners for each tenant in the Application gateway. Cloud API Management 1106 to enable security controls and auditing and monitoring of the Cloud Open-AI models.

Further support tenant-specific infrastructure that may be hosted in different geographic regions and match the incoming request to a tenant through tenant mapping, Monitor/Audit, and Additional security. Logging and monitoring, history (CCB+Stack). Shared Model 1108 includes all tenants perform inference based on the shared workspace (see, 1112). Shared OpenAI may provide the ability build tenant specific models by training them from the data provided by tenants. Dedicated Model 1110 Tenant-specific AI workspace (see, 1112) is built and trained only on the data for a single tenant, and then they are applied to that single tenant. Tenant-specific models are when tenants' data is sensitive. Tenant isolation: Ensure that tenants do not gain unauthorized or unwanted access to the data or models of other tenants. MLOps is to manage the Management planes, used to manage, deploy, test, and version control custom models. A CAM speeds up tenant onboarding processes, enable scaling, and Assured Compliance. A costing 1114 considers a transparent costing model, core-related to tenant's metadata for cost recovery and detect cost anomalies.

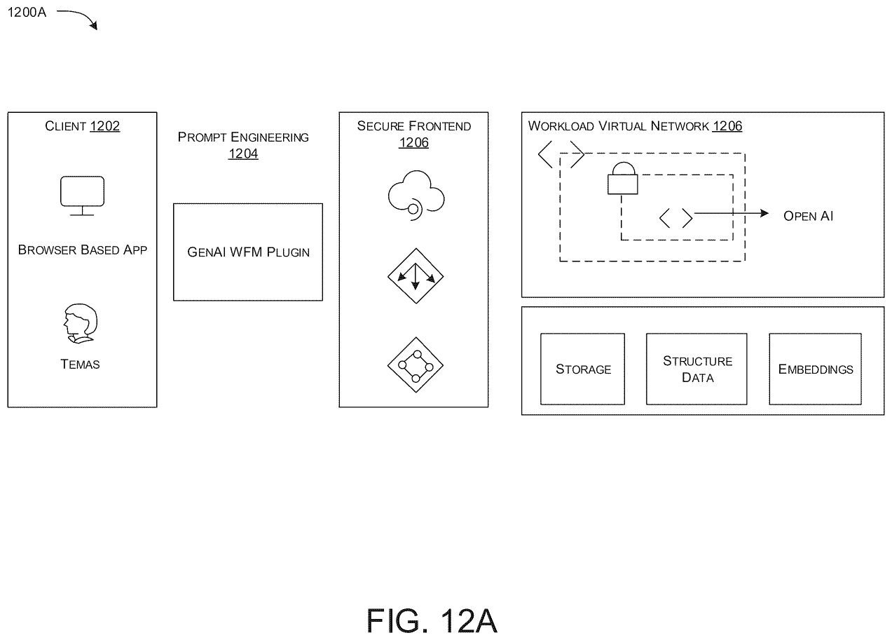

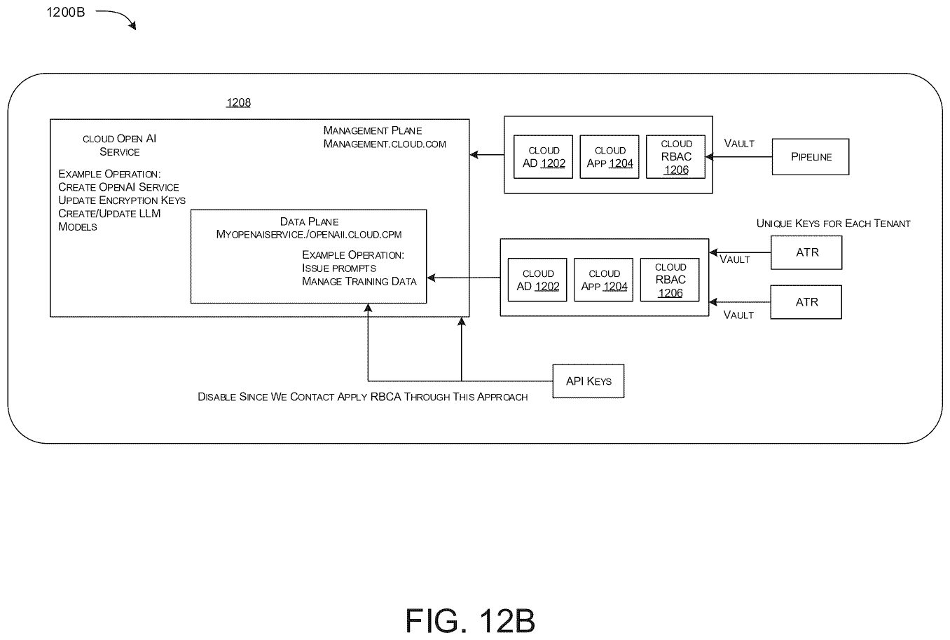

Referring to FIG. 12A in conjunction with FIG. 11, a simplified block diagram representation for secure data storage for multiple clients is shown, in accordance with an embodiment of the present disclosure.

As the solution deals with multiple documents, there is a need to ensure client documents of client 1202 are safe and secure, and one client data is not getting mixed with another. The block diagram representation of FIG. 12A is built using a common Prompt Engineering 1204 method and Cloud PaaS services 1206 that have the technical characteristics of high scalability and broad adaptability, support large-scale intelligence. The block diagram representation of FIG. 12A represents a network data isolation architecture or a data isolation architecture.

Control: Gain better control over user and tenant access. Each security principal (user or tenant) receives a unique API key or service principle, ensuring individual accountability and enabling granular access management.

Accountability: The unique API keys or service principles assigned to each user or tenant allows to track and monitor their usage accurately. This facilitates effective resource allocation, cost management, and security monitoring.

Security: Sharing keys or credentials among multiple users introduces security risks. With this method, the system 102 mitigate these risks by assigning unique API keys or service principals, reducing the potential for unauthorized access or misuse of resources.

Referring to FIG. 12B in conjunction with FIG. 11, a simplified block diagram representation of Role Based Access Control (RBAC) to keep client data secure for multiple clients is shown, in accordance with an embodiment of the present disclosure. The RBAC is capable of performing the following tasks. Task one-Authentication includes the security principal (user or service) authenticates Cloud Active Directory (AAD). This ensures that only authorized entities gain access to our services and resources. Task two includes access Token. Upon successful authentication, the security principal receives an access token from AAD. This access token serves as proof of authentication and is used for subsequent authorization steps. Task three includes authorization via Cloud RBAC: The security principle is then authorized for specific operations against the data hosted within the resource. This authorization is achieved through Cloud Role-Based Access Control (RBAC), which grants fine-grained access permissions based on predefined roles and responsibilities. Task four includes based on the client requirement and sensitivity of the data, a dedicated or shared model 1208 is deployed. The dedicated model may be used for more secure content and the shared model may be used for less secure public data at low cost.

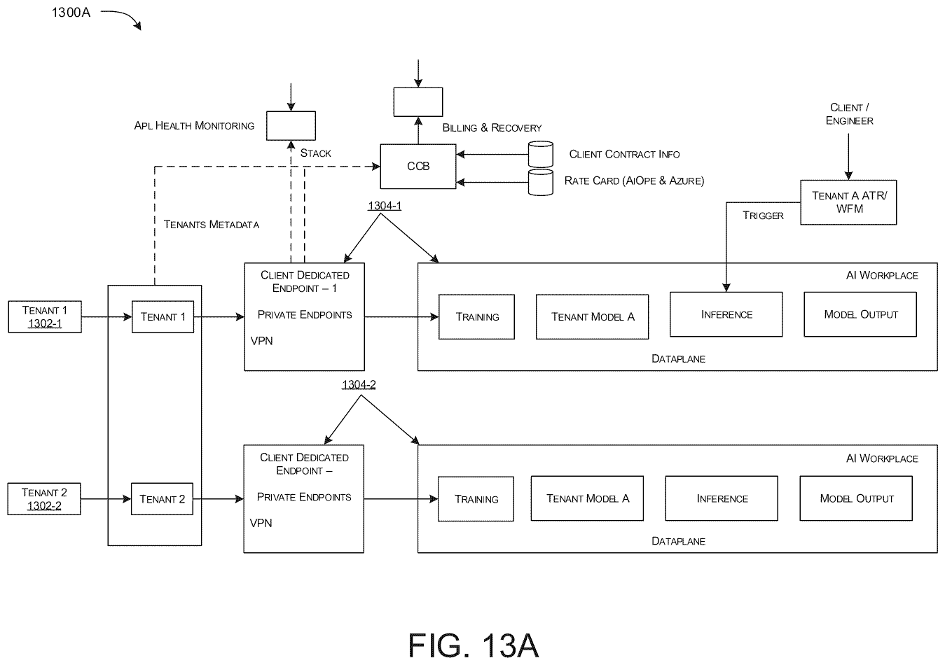

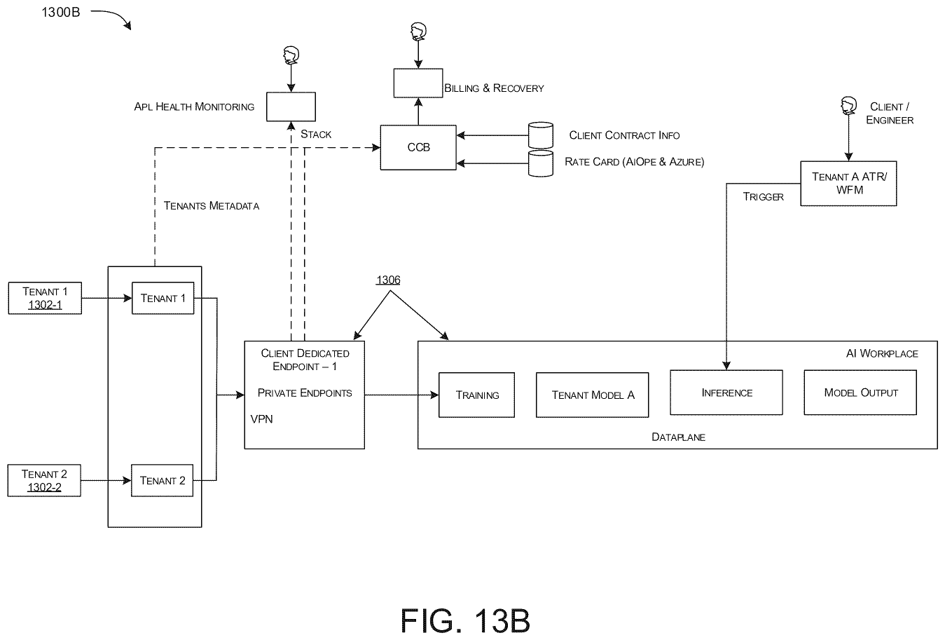

Referring to FIG. 13A in conjunction with FIG. 11, in the shared model-all tenants (such as a tenant 1302-1, and a tenant 1302-2) perform inference based on the shared workspace (such as a shared workspace 1304-1 and a shared workspace 1304-2). The shared workspaces 1304-1 and 1304-2 may provide the ability build tenant specific models by training them from the data provided by tenants.

Referring to FIG. 13B in conjunction with FIG. 11, in the dedicated model-tenant-specific AI workspace (such as a workspace 1306) is built and trained only on the data for a single tenant (such as the tenant 1302-1 or the tenant 1302-2), and then they are applied to that single tenant. The tenant-specific models are when tenants' data is sensitive.

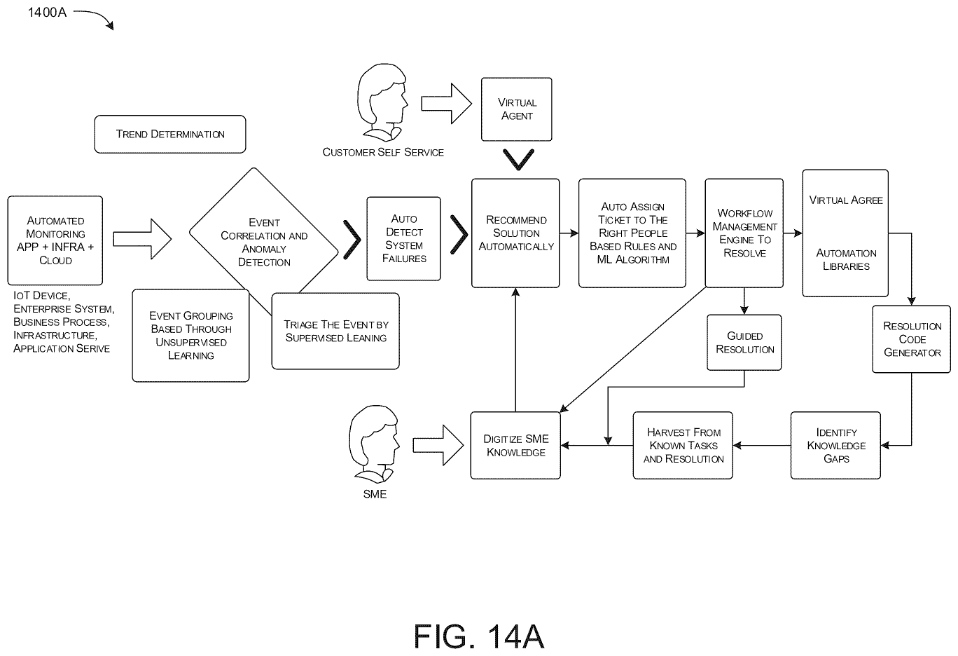

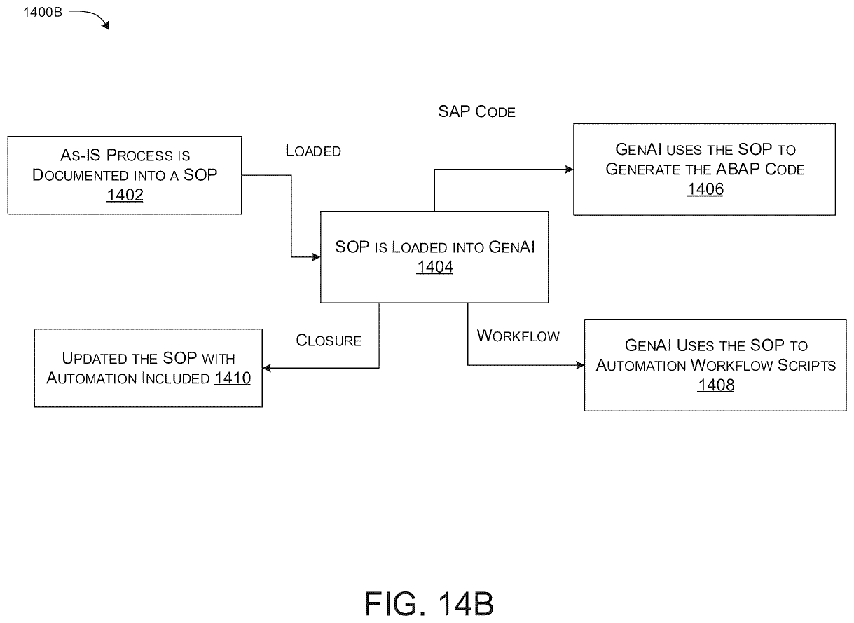

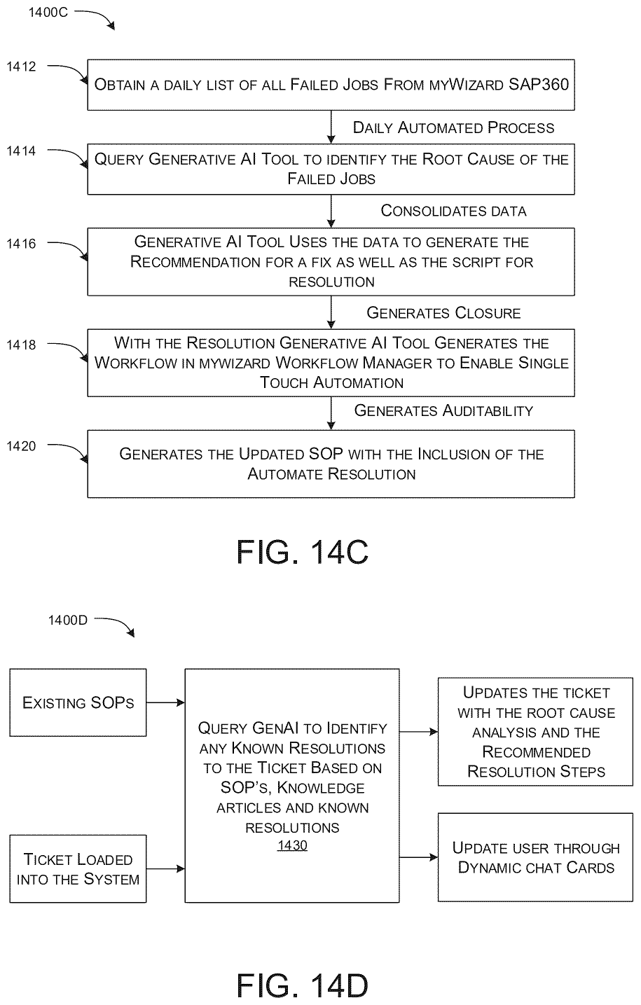

FIG. 14A illustrates an exemplary use case 1400 of Fast tracking the resolution of high priority incidents implementation using GenAI solutions, in accordance with an embodiment of the present disclosure. The GenAI solution for fast tracing the resolutions is built to enhance the ability of a tool to transcribe a ServiceDesk call in real time. This enriches the service ability with a root cause analysis to guide auto resolution and speed to closure. The different phases are:

Current Phase: Post a Service Desk call, the transcript may be loaded into the tool to transcribe the Root Cause Analysis, assign the ticket to the correct team, generate a PI document and automation for resolution.

The tool may join all incoming service calls to listen and transcribe in real time, giving the service agent and end user a faster analysis and resolution.

The tool with the help of generative chat cards may host the incoming service call and ask the end user all the required questions to generate the root cause and resolution.

FIG. 14B illustrates an exemplary use case of automation and knowledge creation implementation using GenAI solutions, in accordance with an embodiment of the present disclosure. The GenAI solution for the automation and knowledge creation is created to allow the generation of automation from an SOP document. This use case uses the tool to configure SOP templated code directly into SOP with the necessary workflows for automation. AS-IS process is documented into a SOP (see, 1402) and loaded to GenAI (see, 1404). Further, the GenAI uses the SOP to generate ABAP code (see, 1406). Then, the GenAI uses the SOP to automation workflow scripts (see, 1408). The GenAI updates the SOP with the automation included (see, 1410).

FIG. 14C illustrates an exemplary use case of report generation using GenAI solutions, in accordance with an embodiment of the present disclosure. The flow uses monitoring and logs to generate audit reports from failed batch jobs 1412. It reads the report (see, 1414) and generates the audit report (see, 1416). Further, the process is enriched with the SOP's required to build automation (see, 1418) to resolve the errors (see, 1420). This is then linked back to the use case of the automation and knowledge creation as explained with reference to FIG. 14B.

FIG. 14D illustrates an exemplary use case of question-and-answer conversational chat using GenAI solutions, in accordance with an embodiment of the present disclosure. The question and answer (Q and A) conversational chat requires the documents to be uploaded and indexed into the tool and make them available for Question and Answer (see, 1430).

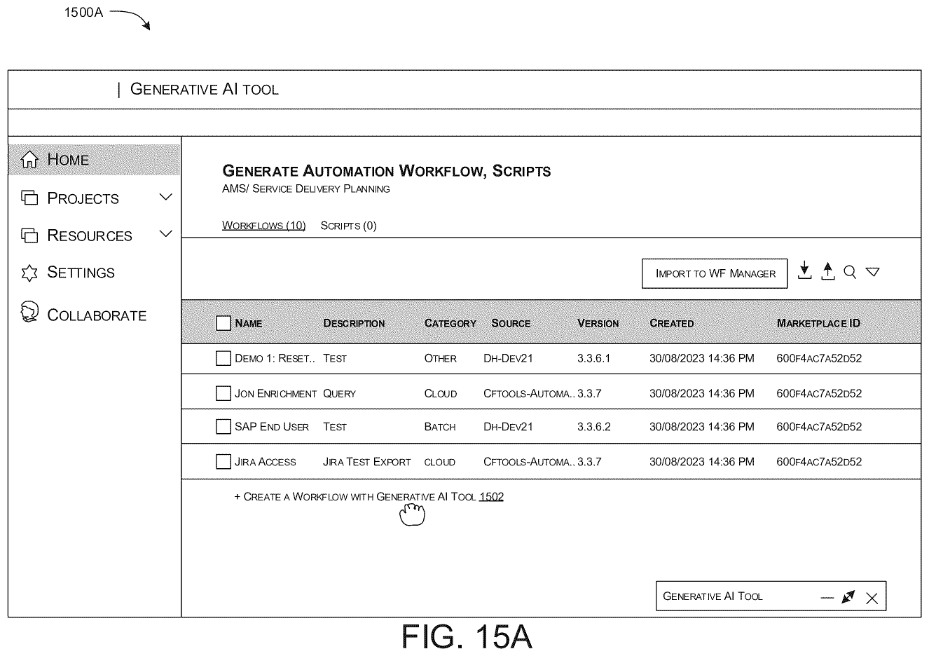

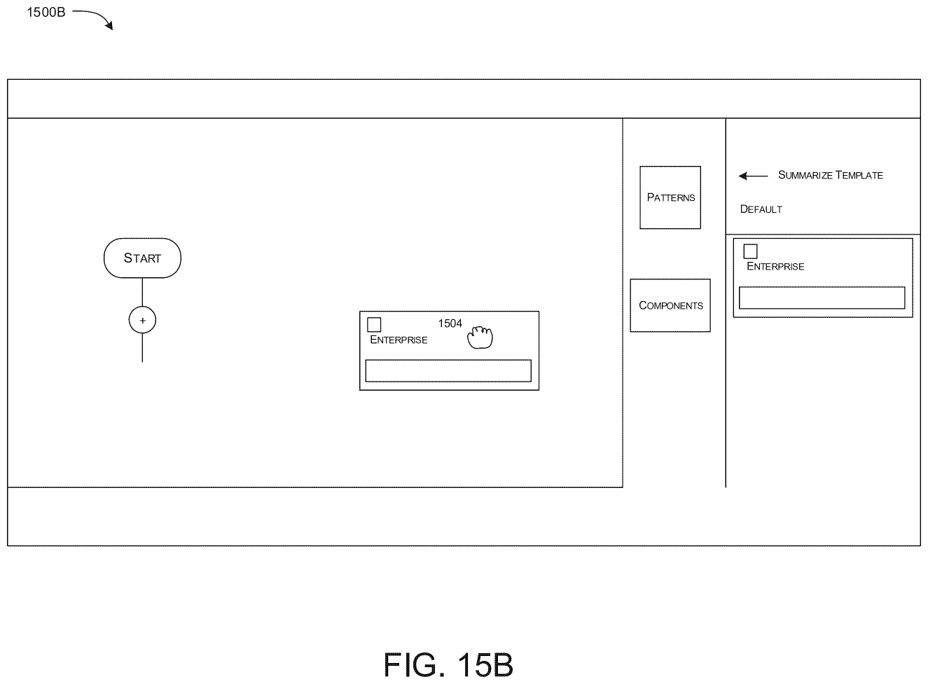

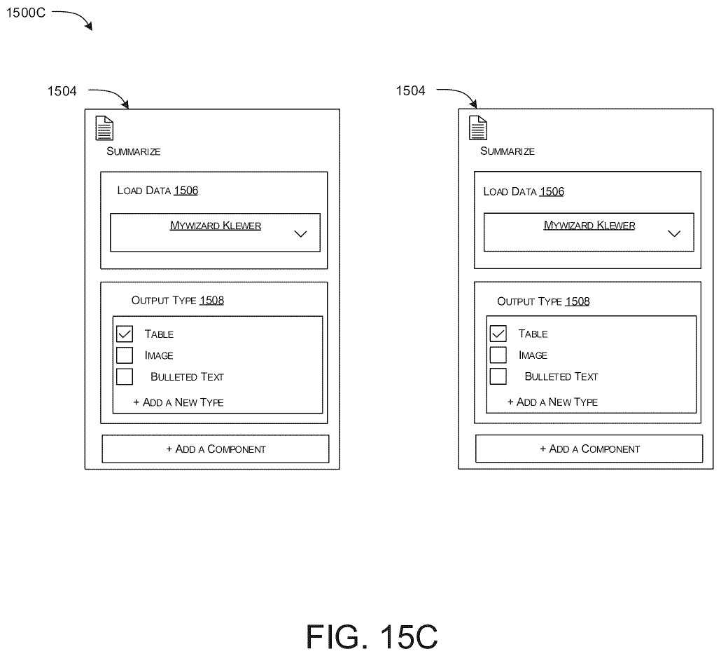

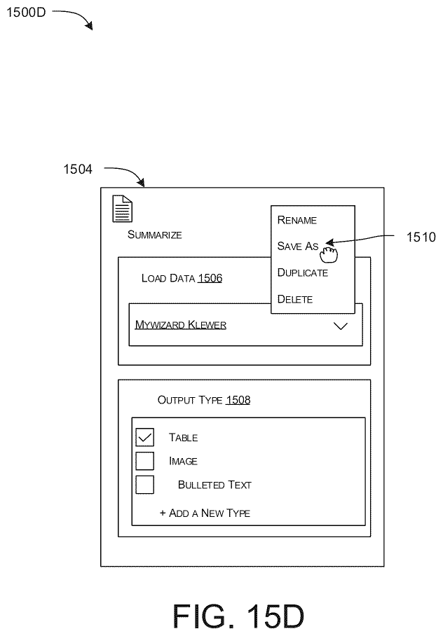

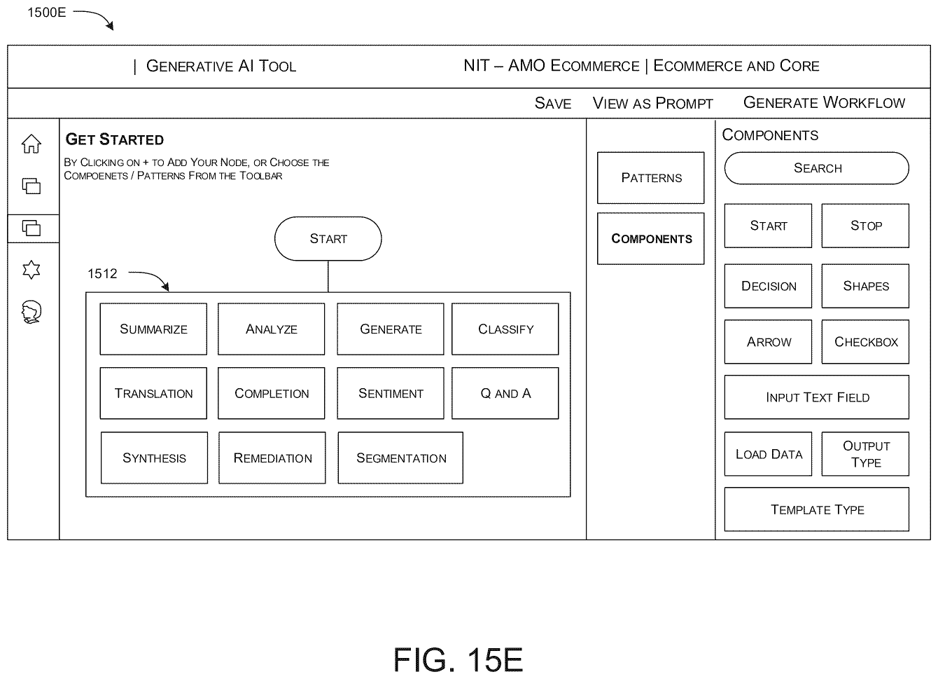

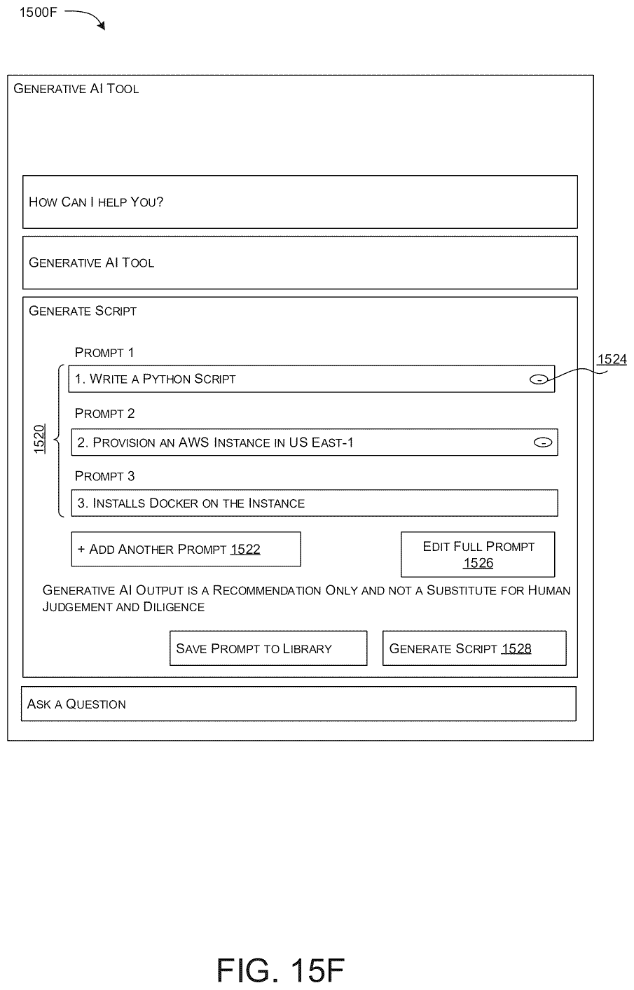

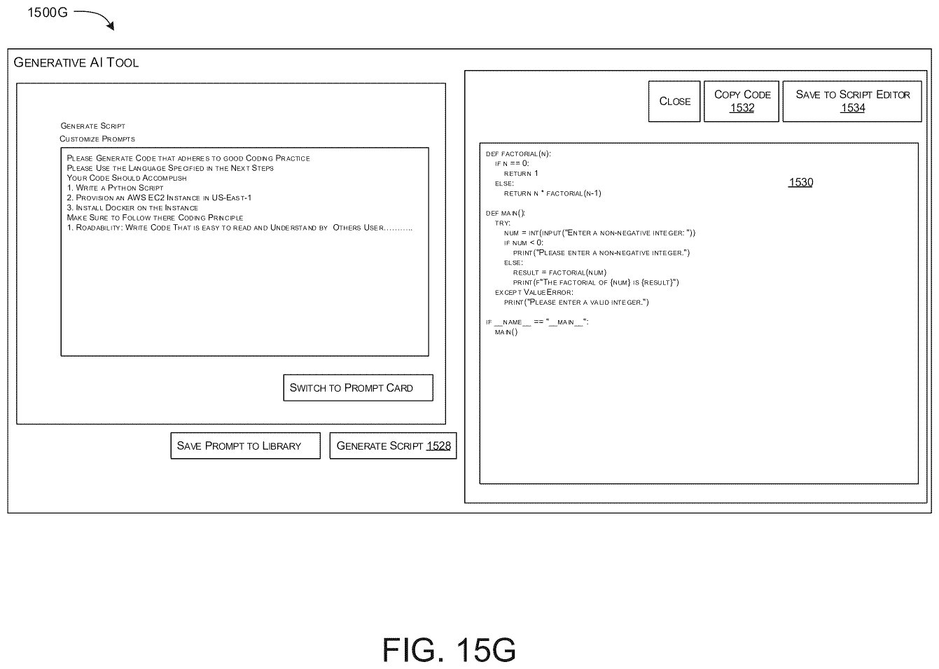

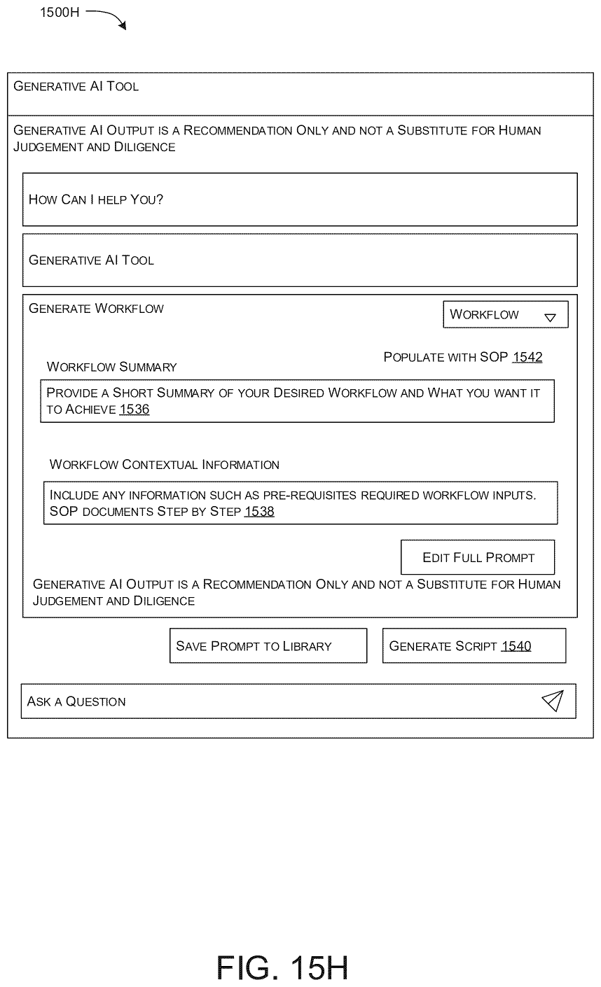

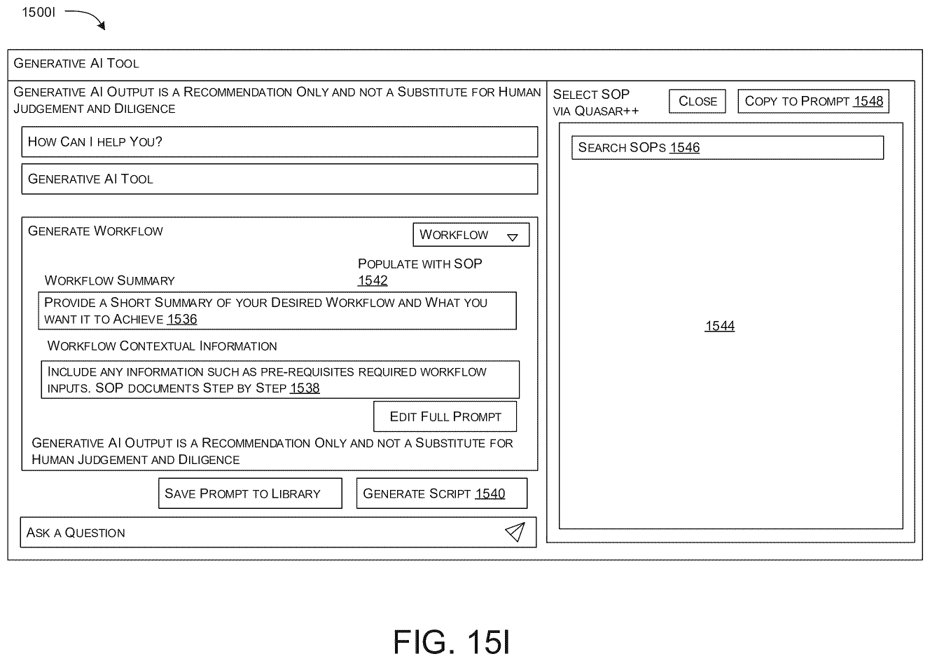

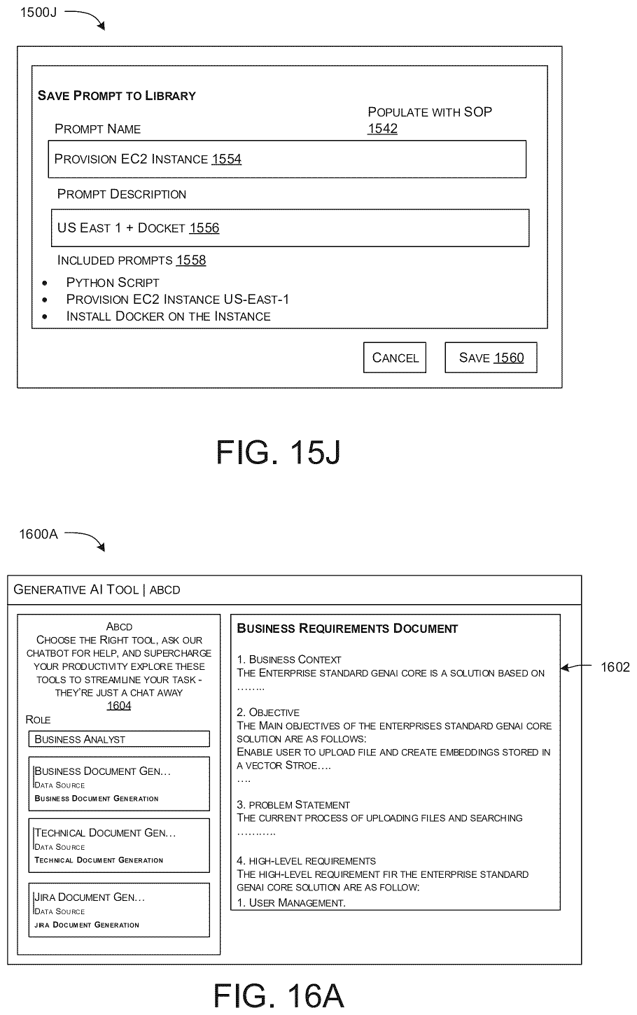

FIGS. 15A to 15J illustrate an exemplary use case depicting generation of a workflow prompt builder, script generation and a workflow generation associated with a workflow manager (WFM) application, in accordance with an embodiment of the present disclosure. To implement the GenAI use cases it is important to have a flexible prompt builder such that the system 102 may standardize the prompts and reuse them.

The Workflow Prompt Builder gives the ability to build more complex prompts through a workflow interface that describes the key process. The system 102 may not only able to build more complex prompts, but also be able to build them through a more visual workflow description.

The user such as the user 108-1 launches the Workflow Prompt Builder (as shown in FIG. 15A). The user 108-1 may provide inputs on option 1502 (exemplarily depicted as ‘create a workflow’).

Thereafter, the user 108-1 starts by selecting a pattern and then drags and drops it onto the system 102 (as shown in FIG. 15B). For example, the selected pattern is ‘summarize pattern’ (see, 1504).

Then the user 108-1 drops into the pattern node relevant components to help describe the prompt for the workflow. Examples of the relevant components include “load data” (see, 1506 of FIG. 15C) and “output type” (see, 1508 of FIG. 15C).

The user 108-1 then saves the workflow by clicking on the save button (see, 1510 of FIG. 15D). In an embodiment, auto-save functionality may exist.

The user 108-1 may then drop in the rest of the relevant patterns and components 1514 required to build the rest of the workflow using branching if required and/or other elements to support the prompt build such as, for example, but not limited to, the decision tree component 1512 (as shown in FIG. 15E). The user 108-1 may also save the nodes as templates, hence they may be re-used for other workflows. Then, the user 108-1 generates the workflow.

By leveraging the generative capability of Artificial Intelligence, the tool reduces the time and effort required to build scripts and workflows, for better execution of workflows.

Further, when generating scripts, the tool allows the user 108 to break down the requirement into ‘prompts’ to get a more refined output as a script. Users may be able to see the generated output and review it before saving it to the script library in WFM. Furthermore, when generating workflows, the tool allows the user 108 to give a summary and any additional context required to generate multiple scripts in the form of a workflow. These scripts may relate to each other and structure in the form of a workflow for the user 108 to execute. The tool allows the user 108 to generate scripts using prompts, to provide a more specific request to LLM. The generation of the script is explained further in detail.

Referring to FIG. 15F, the user such as the user 108-1 may add individual prompts to each prompt section (see, 1520) to outline the details of the required script generation. If the user 108-1 would like to add more prompts, the user 108-1 may press the ‘Add Another Prompt’ button (see, 1522), which may add as many prompts as required. Similarly, if the user 108-1 wants to remove some of the prompts, they may press the red button (see, 1524) on the top right of each prompt to remove it from the card. Further, the user 108-1 may also make edits to the full request that may be sent to OpenAI by pressing the ‘Edit Full Prompt’ button (see, 1526). Once the user 108-1 have added all their required prompts, they may generate the script by pressing the ‘Generate Script’ button (see, 1528).

Referring to FIG. 15G, generated codes (see, 1530) relating to the prompt are rendered to the user 108-1. The user 108-1 may read the prompt here and see if it meets their requirements based on content and objective of the script. In case the generated code is not satisfying with the requirement, the user 108-1 may modify the prompts (or add more) and generate the script again as explained with reference to FIG. 15F. In case, the code satisfies the requirement and requires minor changes, the user 108-1 may copy the code to the clipboard using the ‘Copy Code’ button (see, 1532), or save the generated script to the script editor in WFM by using the ‘Save to Script Editor’ button (see, 1534). Once the ‘Save to Script Editor’ button 1534 is selected, the user 108-1 may have to name the script and then the modal may close. Thereafter, the generated script may be displayed in the WFM Script editor page.

FIG. 15H illustrates an example representation of a user interface depicting workflow generation, in accordance with an embodiment of the present disclosure. The tool allows the user 108-1 to generate the workflows built on sequential script nodes that may be generated by LLM. The user 108-1 may provide inputs such as workflow summary and contextual information to create a structured workflow.

As shown, the user 108-1 may generate the workflows by providing the workflow summary of the task in a workflow summary section 1536. Additional context is not required but is highly suggested to provide more information for the LLM to return a stronger result. Hence, the user 108-1 adds in any context in a workflow contextual information section 1538, and specifically the steps required to execute the task. Then the user 108-1 may provide input on a ‘Generate workflow’ button 1540 to generate the workflow based on the provided inputs.

Referring to FIG. 15I, the WFM is integrated with a tool to extrapolate relevant information from Standard Operating Procedure (SOP's) documents as explained above. Hence, the user 108-1 may directly call upon the task and populate our relevant sections. The user 108-1 may press the ‘Populate with SOP’ button (see, 1542 of FIG. 15G) to search. In this scenario, a side card 1544 may be popped up with a search bar 1546. The user 108-1 may type any key word in the search bar 1546 and the WFM fetches any relevant SOP's that have been uploaded into a processing model. For example, a list of relevant SOP documents may be shown, and the user 108-1 may select among them. If the user 108-1 is satisfied with the list, the user 108-1 may click ‘Copy to Prompt’ button 1548 and the workflow generation card may automatically be populated with those SOP details. Thereafter, the user 108-1 may provide input on the ‘Generate Workflow’ button 1540 and the full workflow may be generated in the workflow software tool.

Further, the user 108-1 may interact with each node and check if the correct/desired output has been generated, including parameters, node names and the actual script for each node.

Furthermore, the WFM may include a button in each node (under the node properties section) to view a script in the script editor. The user 108-1 clicks the ‘View in editor’ button (not shown in Figures) to review the script and make alterations. Once the user 108-1 have reviewed the relevant scripts in each node, the user 108-1 continues to review the remaining details of the workflow and execute the workflow when required.

In addition, when calling the LLM endpoint, the WFM sends more prompts than the summary/additional context that was provided by the user 108-1. This information was curated to output the required generated content in a way that would work with the Workflow Manager application. The full prompt sent by the WFM may be viewed and edited by pressing the ‘Edit Full Prompt’ button (see, 1552 of FIG. 15I) on the Workflow Generation card. Further, when the user 108-1 has filled out the prompts in either the script generation card or the workflow generation card, the user 108-1 may press the ‘Save to Prompt’ Library button (see, 1550 of FIG. 15I) to save it.

Upon providing input on the button 1550, the user 108-1 is provided with a user interface to receive the name for the prompt set and the description in a prompt name section (see, 1554 of FIG. 15J) and a prompt description section (see, 1556 of FIG. 15J), respectively. The user 108-1 may also be able to view the components included in that prompt library to confirm actions being performed (see, 1558 of FIG. 15J). Once satisfied with the details, the user 108-1 may press ‘Save’ button (1560 of FIG. 15J) and the prompt may be saved to the Prompt Library.

Further, when saving workflow prompts, the steps are the same. The difference here is that the user 108-1 may not view the prompts that are included, as they are usually very lengthy. When editing the full prompt, the user 108-1 may save them as a separate prompt set. This may be displayed as a different type of prompt set in the prompt library.

The user 108-1 may access the prompt library to reuse the prompts. Further, the user 108-1 may filter between the prompts for scripts and workflows, whilst also being able to identify which workflow prompts are full raw prompts (e.g., via the Blue RAW′ tag). Once the user 108-1 finds the prompt, the user 108-1 may select it and the filled-out card appears in the tool to be used (not shown in Figures).

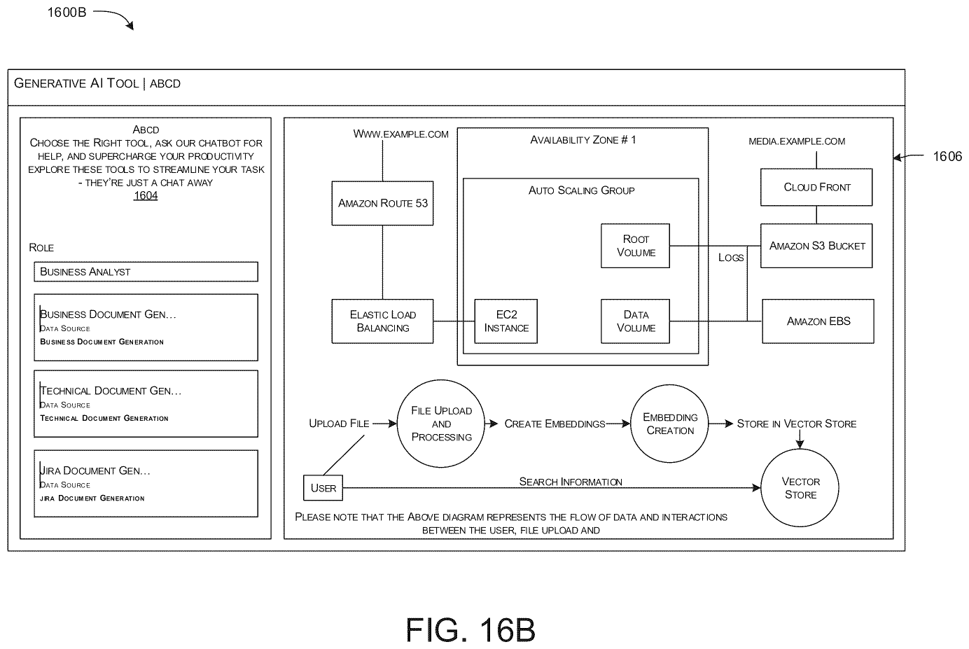

FIGS. 16A and 16B illustrate an exemplary use case of a GenAI powered generation-oriented tool, in accordance with an embodiment of the present disclosure. As shown in FIG. 16A, the user 108 may upload the documents by providing inputs in a user interface (see, 1602). Further, the user 108 may choose a suitable tool from a tool section to query a chatbot and streamline the task (see, 1604). The tool relates to software applications for generation-oriented and data analysis tasks (see, 1606 of FIG. 16B). Specifically, it leverages generalized artificial intelligence (GenAI) to enhance user productivity across various industries.

Existing generation-oriented and data analysis tasks often require specific technical knowledge or are tailored for niche industries. Users from diverse fields face challenges in adapting these tools to their unique needs. Moreover, the integration of AI in such tools often lacks a focus on user experience, making them less accessible to a broader audience. The detailed description of the tool is disclosed below. Architecture-system 102 features a modular architecture, enhancing flexibility and ease of maintenance. The core modules may include a user Interface (UI): A dynamic and responsive interface that provides a seamless user experience. Further, the core module may include GenAI Engine: The powerhouse of the application, responsible for processing and understanding user inputs, and executing tasks. Further, the core module may include customization modules: Allow users to tailor the software to their specific industry needs and preferences. Further, the core module may include GenAI Engine—The GenAI engine is at the prime model of the software tool, endowed with advanced capabilities such as, for example, but not limited to, Natural Language Processing (NLP): Enables the software to understand and interpret human language, both in written and spoken forms. Further, the core module may include for example a recognition: Identifies user requests and categorizes tasks accordingly for effective handling. Further, the core module may include Context Understanding: Interprets the context of user inputs to provide relevant and accurate responses. Further, the core module may include General logic: Enables the system 102 to assist users with general human logic because of the power of GenAI. Users may expect the system 102 to think, analyze and process tasks such as, for example, but not limited to, a knowledgeable and intelligent human.

The engine may process inputs in various forms, including text and table data, making the software versatile in different work environments. User Interface (UI)—The UI of the system 102 is designed with a focus on intuitiveness and ease of use: Intuitive usage: user may easily get started without any training; the UX/UI was designed to allow user to use the tool freely instead of limiting user to use the tool in a specific way. Easy Navigation: Intuitive menus and navigation paths that minimize the learning curve for inexperienced users. Customizable Widgets: Allows users to personalize their roles and tasks to their specific needs. Accessibility Features: Ensures that the software is usable by people with various disabilities.

The UI adapts to different industries through industry-specific templates and tools, enhancing relevance and usability in diverse settings. Industry Adaptability—the system 102 is designed to be highly adaptable to various industries: Pre-set Configurations: Offers out-of-the-box configurations tailored for sectors such as, for example, but not limited to, IT, human resources (HR), finance, and the like. Customization: Users may modify these settings to suit their specific operational needs. Case Scenarios: For instance, the system 102 may help to analyze incident records and project planning, it may also assist in project planning, solutioning and capacity planning and management and more.

Productivity Tools—The software includes a wide range of productivity tools: Automated Document Generation: Streamlines the creation of reports, forms, and other documents. Task Prioritization Algorithms: Helps users manage their workload by prioritizing tasks based on urgency and importance. Template based content generation: Helps user to generate content based on their existing template. External system integration: Allows user to integrate with external systems as the knowledge base, publish/import generated content, download documents and the like.

Data Security and Privacy—the system 102 incorporates robust data security and privacy measures: User Authentication: Implements strong authentication mechanisms to protect user accounts. Compliance: Adheres to international data protection regulations from Company. Implementation and Compatibility—The software is designed for broad compatibility and ease of implementation Cloud Integration: Offers cloud-based options for enhanced accessibility and collaboration.

Further, the GenAI-powered generation-oriented tool is capable of handling various data types and structures. The features of the tool are listed below. Data Type Compatibility—the system 102 is designed to work seamlessly with a variety of data types including text, numeric data, and images. This flexibility ensures that users from different industries may utilize the software with their specific data formats.

Text and Numeric Data—The software intelligently processes and organizes text and numeric data. It includes features for text parsing, data categorization, and advanced calculations. Users may input raw data in these formats, and the system 102 may efficiently structure and present them in a user-friendly manner.

Image Processing and Analysis—this system 102 incorporates advanced image recognition and processing capabilities. It may analyze images, categorize them, and integrate them into relevant documents. For instance, in a medical setting, the system 102 could automatically include and label medical imaging in reports.

Diagrams and Graphical Data—the system 102 supports the creation and manipulation of various diagram types, such as flowcharts, organizational charts, and data visualizations. Users may input raw data, and the software may generate graphical representations. Additionally, users may manually create or edit diagrams using intuitive tools.

Tables and Data Organization—The software excels in organizing data into tables, facilitating easy data entry, editing, and sorting. This is particularly useful for financial, research, and educational applications, where data organization is key.

Integration with External Data Sources—the system 102 may integrate with external databases and data sources, allowing users to import and export data in various formats.

Custom Data Structures-Recognizing the diverse needs of different industries, the system 102 allows users to create custom data structures. This feature ensures that the software may adapt to unique data handling requirements, enhancing its versatility across various fields.

Data Visualization and Reporting—The present system provides robust data visualization features, enabling users to create comprehensive reports and presentations. These tools may include a range of customizable charts, graphs, and interactive elements that make complex data easily understandable.

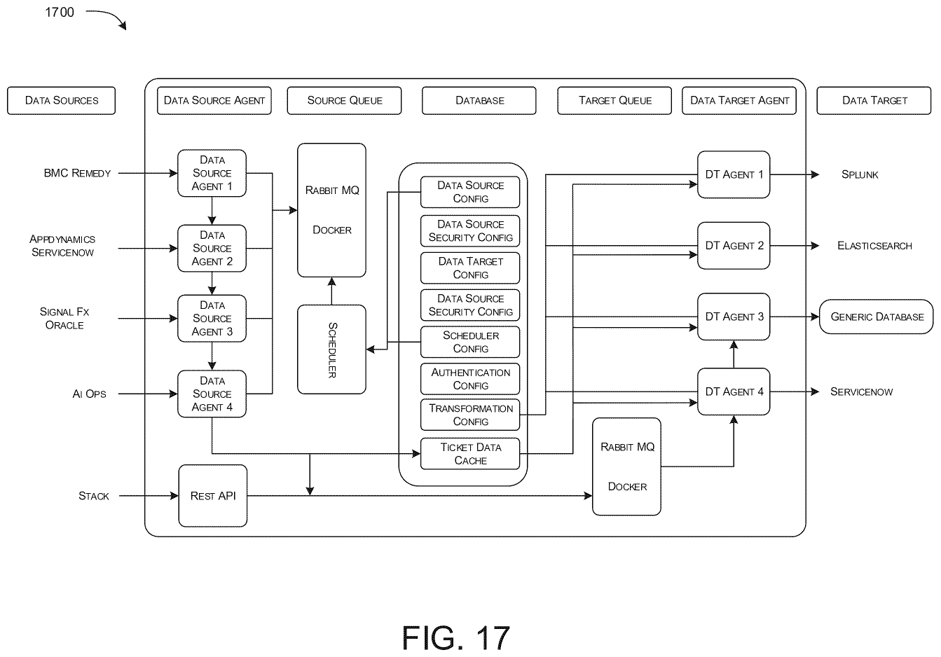

FIG. 17 illustrates an exemplary use case of enriching data while pulling data through service integrator, in accordance with an embodiment of the present disclosure. The system 102 Service Integrator tool allows to pull data from various REST API based data sources, transforms it, and sends it to multiple targets.

Using GenAI the data may be categorized based on the description fields. Example while pulling the incident data the incident category may be auto calculated. In another example any missing field may be auto populated, for example, if assignment group is missing it may be auto suggested. Further, some of the benefits while pulling data through a service integrator are listed below:
1. Data Augmentation—Complete the missing data.
2. Data classification: classify data based on incident description or any other fields.
3. Data summary generation—Summarize long incident comments.
4. Auto generate transformation mapping based on input and output data.
5. Auto generation of plugin code based on a template.
6. Auto generate visualization code.

Additionally, the system 102 implementing the Gen AI based solution is capable of handling other use cases such as, for example:
a. Code optimization to enable code defect fixes and code performance optimization.
b. Code forward engineering (new service code creation built from application architecture and software architecture design documents).
c. Code reverse engineering (discovery of code to produce detailed requirements, use case and design documents) to the use case description of the code.
d. Ability to handle multiple languages. The solution provides feature to ask question in any language where the original document is in different language e.g. user can ask question in Japanese from an English document and get the answer in Japanese.
e. Ability to generate documents from template, for example, generating company policy documents based on existing company templates and new requirements.
f. To keep the client data secured this solution provides the option to mask secured data based on configuration.

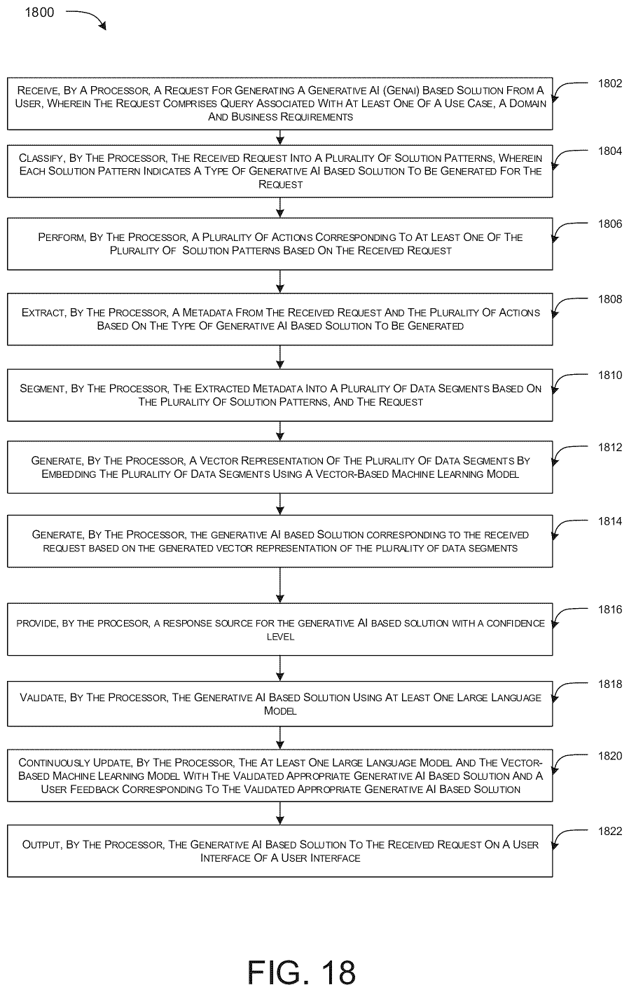

FIG. 18 illustrates a flow chart depicting a method 1800 for generating GenAI based solution, in accordance with the embodiments of the present disclosure.

The method 1800 may be implemented in any suitable hardware, software, firmware, or combination thereof. The order in which the method 1800 is described is not intended to be construed as a limitation, and any number of the described method blocks may be combined or otherwise performed in any order to implement the method 1800 or an alternate method. Additionally, individual blocks may be deleted from the method 1800 without departing from the spirit and scope of the present disclosure described herein. Furthermore, the method 1800 may be implemented in any suitable hardware, software, firmware, or a combination thereof, that exists in the related art or that is later developed. The method 1800 describes, without limitation, the implementation of the system 102. A person of skill in the art may understand that method 1800 may be modified for implementation in various manners without departing from the scope and spirit of the disclosure.

At block 1802, the method 1800 includes receiving, by the processor 114, a request for generating a generative AI (GenAI) based solution from a user. The request includes queries associated with at least one of a use case, a domain and product requirements.

At block 1804, the method 1800 includes classifying, by the processor 114, the received request into a plurality of solution patterns. Further, each solution pattern indicates a type of generative AI based solution to be generated for the request.

At block 1806, the method 1800 includes performing, by the processor 114, a plurality of actions corresponding to at least one of the plurality of solution patterns based on the received request.

At block 1808, the method 1800 includes extracting, by the processor 114, a metadata from the received request and the plurality of actions based on the type of generative AI based solution to be generated.

At block 1810, the method 1800 includes segmenting, by the processor 114, the extracted metadata into a plurality of data segments based on the plurality of solution patterns, and the request.

At block 1812, the method 1800 includes generating, by the processor 114, a vector representation of the plurality of data segments by embedding the plurality of data segments using a vector-based machine learning model.

At block 1814, the method 1800 includes generating, by the processor 114, the generative AI based solution corresponding to the received request based on the generated vector representation of the plurality of data segments.

At block 1816, the method 1800 includes providing, by the processor 114, a response source for the generative AI based solution with a confidence level.

At block 1818, the method 1800 includes validating, by the processor 114, the generative AI based solution using at least one large language model.

At block 1820, the method 1800 includes continuously updating, by the processor 114, the at least one large language model and the vector-based machine learning model with the validated generative AI based solution and a user feedback corresponding to the validated generative AI based solution.

At block 1822, the method 1800 includes outputting, by the processor 114, the generative AI based solution to the received request on a user interface of a user interface. The one or more operations performed by the processor 114 to generate the GenAI based solution are already explained with reference to FIGS. 1 to 17, therefore they are not reiterated herein for the sake of brevity.

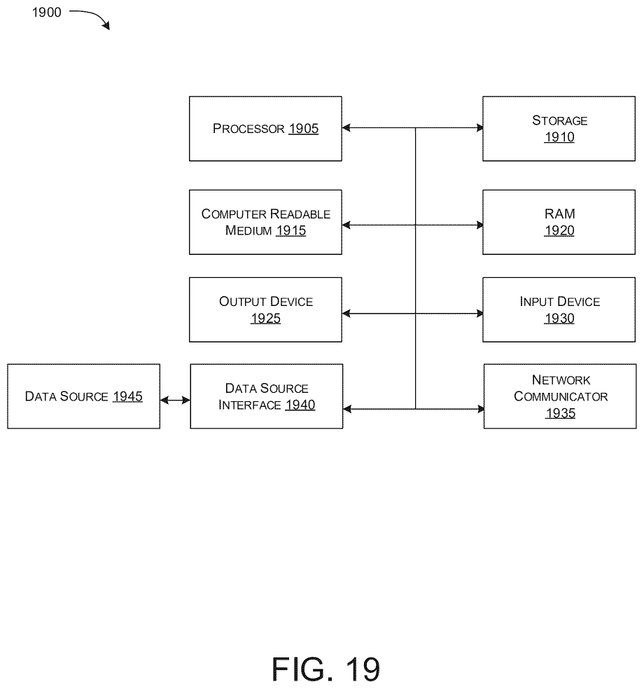

FIG. 19 illustrates an exemplary block diagram representation of a hardware platform 1900 for implementation of the disclosed system 102, in accordance with embodiments of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform 1900. As illustrated, the hardware platform 1900 may include additional components not shown, and some of the components described may be removed and/or modified. For example, a computer system with multiple GPUs may be located on external-cloud platforms, internal corporate cloud computing clusters, or organizational computing resources.

The hardware platform 1900 may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., random access memory (RAM), read-only memory (ROM), erasable, programmable ROM (EPROM), electrically erasable, programmable ROM (EEPROM), hard drives, and flash memory). The computer system may include a processor 1905 that executes software instructions or code stored on a non-transitory computer-readable storage medium 1915 to perform methods of the present disclosure. The software code includes, for example, instructions to gather data and analyze the data.

The instructions on the computer-readable storage medium 1915 are read and stored the instructions in storage 1910 or random-access memory (RAM) 1920. The computer-readable storage medium 1915 may provide a space for keeping static data where at least some instructions could be stored for later execution. The stored instructions may be further compiled to generate other representations of the instructions and dynamically stored in the RAM such as RAM 1920. The processor 1905 may read instructions from the RAM 1920 and perform actions as instructed.

The computer system 102 may further include the output device 1925 to provide at least some of the results of the execution as output including, but not limited to, visual information to users, such as external agents. The output device 1925 may include a display on computing devices and virtual reality glasses. For example, the display may be a mobile phone screen or a laptop screen. GUIs and/or text may be presented as an output on the display screen. The computer system 102 may further include an input device 1930 to provide a user or another device with mechanisms for entering data and/or otherwise interacting with the computer system 102. The input device 1930 may include, for example, a keyboard, a keypad, a mouse, or a touchscreen. Each of these output devices 1925 and input device 1930 may be joined by one or more additional peripherals. For example, the output device 1925 may be used to display the results such as bot responses by the executable chatbot.

A network communicator 1935 may be provided to connect the computer system 102 to a network and in turn to other devices connected to the network including other clients, servers, data stores, and interfaces, for example. A network communicator 1935 may include, for example, a network adapter such as a LAN adapter or a wireless adapter. The computer system 102 may include a data sources interface 1940 to access the data source interface 1945. The data source interface 1945 may be an information resource. As an example, a database of exceptions and rules may be provided as the data source interface 1945. Moreover, knowledge repositories and curated data may be other examples of the data source interface 1945.

The present disclosure provides a system and a method for generating GenAI based solution and competitive advantages that are listed below.

The GenAI based solution provides a unique user experience. The unique user experience design of the software tool, which includes an intuitive user interface (UI) that adapts to the specific needs and workflows of users across various industries. This claim encompasses the software's ability to provide a seamless and personalized experience through customizable dashboards, widgets, and accessibility features.

Further, the GenAI based solution provides a modular architecture of the software tool, enabling flexibility and customization. This includes the separation of the user interface, the GenAI engine and customization modules, allowing each component to be independently updated, modified, or replaced to suit industry-specific requirements.

The system includes an adaptive GenAI engine that is capable of natural language processing, task recognition, context understanding, and adaptive learning. The engine has the ability to process user inputs in various forms and generate accurate, context-aware responses, thereby enhancing the efficiency and effectiveness of task management and documentation.

The present disclosure provides industry-specific customization which enables the software's ability to adapt to different industries through pre-set configurations and user-driven customization options. This includes the use of industry-specific templates and tools, and the ability to modify these settings to meet unique operational needs, as demonstrated in various case scenarios.

Further, there is inherent scalability and expandability of the software tool, which is designed to easily scale up and accommodate the growing needs of an organization. The software's capability may be expanded to more industries, facilitated by its modular design and adaptive GenAI engine, allowing for continuous evolution and adaptation to new market demands and industry trends.

Furthermore, the system includes integrated productivity tools which enhances user productivity and workflow efficiency. The data security and compliance software's commitment to safeguards user data and maintaining privacy standards.

The system and method of the present invention further provides the following technical advantages:
1. Collecting various types of structured and unstructured data which requires integration with multiple tools.
2. Preprocessing and transforming the data in a way that is usable for the use cases.
3. Extraction of content from images to make it searchable.
4. Integration with various LLMs.
5. Resolving the ambiguity between various sources with user feedback and follow-up questions.
6. Making the document searchable through various API exposed by the tool.
7. Providing a confidence score of the answer so that various automation decisions can be taken accurately.
8. Provide option for priority-based search, example if answer is not found in source 1, look for an answer in source 2.
9. Reusable framework for commonly used Generative AI use cases, example Search a set of use cases and generate test cases for all of them.
10. Automatically generate prompts using a dynamic set of data.
11. Handling token limitation by various LLMs.
12. Generating documents from templates.
13. Generating documents based on personas.
14. Generating code from application architecture documents.
15. Handling multiple languages e.g. English, Japanese.
16 Source code migration from one language to another and code modernization.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it may be apparent that more than one device/article (whether or not they cooperate) may be used in place of a single device/article. Similarly, where more than one device or article is described herein (whether or not they cooperate), it may be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development may change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are performed. Alternatives (including equivalents, extensions, variations, deviations, and the like, of those described herein) may be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A system, comprising:
a processor; and
a memory communicably coupled to the processor, wherein the memory comprises processor-executable instructions which, when executed by the processor, cause the processor to:
receive a request for generating a generative AI (GenAI) based solution from a user, wherein the request comprises query associated with at least one of a use case, a domain and product requirements;
classify the received request into a plurality of solution patterns, wherein each solution pattern indicates a type of GenAI based solution to be generated for the request;
perform a plurality of actions corresponding to at least one of the plurality of solution patterns based on the received request;
extract a metadata from the received request and the plurality of actions based on the type of GenAI based solution to be generated;
segment the extracted metadata into a plurality of data segments based on the plurality of solution patterns, and the request;
generate a vector representation of the plurality of data segments by embedding the plurality of data segments using a vector-based machine learning model;
generate the GenAI based solution corresponding to the received request based on the generated vector representation of the plurality of data segments;
provide a response source for the GenAI based solution with a confidence level;
validate the GenAI based solution using at least one large language model (LLM);
continuously update the at least one LLM and the vector-based machine learning model with the validated based solution and a user feedback corresponding to the validated GenAI based solution; and
output the GenAI based solution to the received request on a user interface.

2. The system of claim 1, wherein the plurality of solution patterns comprise a generation pattern, a completion pattern, a synthesis pattern, an analysis pattern, a summarization pattern, a sentiment analysis pattern, a remediation pattern, a segmentation pattern, a translation pattern, a question-and-answer pattern, and a classification pattern.

3. The system of claim 1, wherein in performing the plurality of actions corresponding to at least one of the plurality of solution patterns based on the received request, the processor is configured to:
identify a plurality of tasks associated with the plurality of solution patterns based on the received requirements;
identify a type of input parameters and a type of output parameters associated with the identified plurality of tasks based on type of tasks, task properties and sequence of execution of each task; and
execute the plurality of tasks associated with the plurality of solution patterns based on the identified type of input parameters and the type of output parameters.

4. The system of claim 1, wherein in performing the plurality of actions corresponding to at least one of the plurality of solution patterns based on the received request, the processor is configured to:
receive a solution pattern selected for performing the plurality of actions;
pre-process the received request based on the solution pattern;
generate a graphical user-interface (GUI) corresponding to the solution pattern;
determine a plurality of solution pattern properties associated with the solution pattern; and
perform the plurality of actions on the generated GUI based on the determined plurality of solution pattern properties.

5. The system of claim 1, wherein in extracting metadata from the received request and the plurality of actions, the processor is configured to:
extract plain text from the received request and the plurality of actions performed; and
determine the metadata associated with the extracted plain text, wherein the metadata comprises use case properties, type of product requirements, content of the use case, domain category, document version information, user defined inputs, and additional requests from the user.

6. The system of claim 1, wherein in generating the vector representation of the plurality of data segments by embedding the plurality of data segments using the vector-based machine learning model, the processor is configured to:
embed the plurality of data segments using the vector-based machine learning model by merging raw data of the received request with the extracted metadata and a vector value;
generate the vector representation of the embedded plurality of data segments; and
store the generated vector representation in a corresponding vector database node.

7. The system of claim 1, wherein in generating the GenAI based solution corresponding to the received request based on the generated vector representation of the plurality of data segments, the processor is configured to:
perform a similarity search for the generated vector representation by comparing the generated vector representation with at least one vector representation of the pre-stored plurality of data segments;
determine a similarity score for the generated vector representation based on results of the similarity search and a priority level of the generated vector representation; and
generate the GenAI based solution corresponding to the received request based on the determined similarity score.

8. The system of claim 1, wherein in generating the GenAI based solution corresponding to the received request based on the generated vector representation of the plurality of data segments, the processor is configured to:
map the generated vector representation with at least one vector representation of the pre-stored plurality of data segments;
generate an embedded response comprising the mapped data segments and a part of the received request;
determine whether the generated embedded response complies with predefined organization rules; and
convert the generated embedded response to a large language model (LLM) readable file based on the results of determination.

9. The system of claim 1, wherein in validating the GenAI based solution using the at least one LLM, the processor is configured to:
determine an intent of the received request from the user by parsing contents of the received request;
determine a LLM for validating the GenAI based solution based on the determined intent and by comparing the contents of the received request with a plurality of pre-stored LLM descriptions;
determine a token usage limit of the determined LLM by accessing LLM properties of the determined LLM;
route the GenAI based solution to the determined LLM for validation;
apply trained large language models (LLMs) to the GenAI based solution based on the determined intent;
determine a confidence score associated with the GenAI based solution based on the results of the application of the trained LLMs;
update the GenAI based solution based on the determined confidence score; and
generate a response to the received request, wherein the response comprises the updated GenAI based solution.

10. The system of claim 1, wherein in generating the GenAI based solution, the processor is configured to perform at least one of: generate answers to at least one question from the user using a vector database; generate answers to automated voice mails; generating summary of the automated voice calls; generate a document on root cause analysis of a use case, generate a plurality of test cases from a plurality of user stories; generate explanation of a code, generate a test data for test cases, co-relate test cases with the plurality of user stories, analyze large relational data and recommending decisions, analyze diagrams in architecture documents, generate documents from a chat history, generate a document from a template, generate a source code from a requirement document, generate a plurality of artificial intelligence (AI)-based insights from an indexed data and generate workflows for the use case, wherein the workflows are generated using code scripts and wherein the code scripts are generated using prompts.

11. A method comprising:
receiving, by a processor, a request for generating a generative AI (GenAI) based solution from a user, wherein the request comprises query associated with at least one of a use case, a domain and product requirements;
classifying, by the processor, the received request into a plurality of solution patterns, wherein each solution pattern indicates a type of the GenAI based solution to be generated for the request;
performing, by the processor, a plurality of actions corresponding to at least one of the plurality of solution patterns based on the received request;
extracting, by the processor, a metadata from the received request and the plurality of actions based on the type of GenAI based solution to be generated;
segmenting, by the processor, the extracted metadata into a plurality of data segments based on the plurality of solution patterns, and the request;
generating, by the processor, a vector representation of the plurality of data segments by embedding the plurality of data segments using a vector-based machine learning model;
generating, by the processor, the GenAI based solution corresponding to the received request based on the generated vector representation of the plurality of data segments;
providing, by the processor, a response source for the GenAI based solution with a confidence level;
validating, by the processor, the GenAI based solution using at least one large language model (LLM);
continuously updating, by the processor, the at least one LLM and the vector-based machine learning model with the validated GenAI based solution and a user feedback corresponding to the validated GenAI based solution; and
outputting, by the processor, the GenAI based solution to the received request on a user interface of a user interface.

12. The method of claim 11, wherein performing the plurality of actions corresponding to at least one of the plurality of solution patterns based on the received request comprises:
identifying, by the processor, a plurality of tasks associated with the plurality of solution patterns based on the received requirements;
identifying, by the processor, a type of input parameters and a type of output parameters associated with the identified plurality of tasks based on type of tasks, task properties and sequence of execution of each tasks; and
executing, by the processor, the plurality of tasks associated with the plurality of solution patterns based on the identified type of input parameters and the type of output parameters.

13. The method of claim 11, wherein performing the plurality of actions corresponding to at least one of the plurality of solution patterns based on the received request comprises:
receiving, by the processor, a solution pattern selected for performing the plurality of actions;
pre-processing, by the processor, the received request based on the solution pattern;
generating, by the processor, a graphical user-interface (GUI) corresponding to the solution pattern;
determining, by the processor, a plurality of solution pattern properties associated with the solution pattern; and
performing, by the processor, the plurality of actions on the generated GUI based on the determined plurality of solution pattern properties.

14. The method of claim 11, wherein extracting metadata from the received request and the plurality of actions comprises:
extracting, by the processor, plain text from the received request and the plurality of actions performed; and
determining, by the processor, the metadata associated with the extracted plain text, wherein the metadata comprises use case properties, type of product requirements, content of the use case, domain category, document version information, user defined inputs, and additional requests from the user.

15. The method of claim 11, wherein generating the vector representation of the plurality of data segments by embedding the plurality of data segments using the vector-based machine learning model comprises:
embedding, by the processor, the plurality of data segments using the vector-based machine learning model by merging raw data of the received request with the extracted metadata and a vector value;
generating, by the processor, the vector representation of the embedded plurality of data segments; and
storing, by the processor, the generated vector representation in a corresponding vector database node.

16. The method of claim 11, wherein generating the GenAI based solution corresponding to the received request based on the generated vector representation of the plurality of data segments comprises:
performing, by the processor, a similarity search for the generated vector representation by comparing the generated vector representation with at least one vector representation of the pre-stored plurality of data segments;
determining, by the processor, a similarity score for the generated vector representation based on results of the similarity search and a priority level of the generated vector representation; and
generating, by the processor, the GenAI based solution corresponding to the received request based on determined similarity score.

17. The method of claim 11, wherein generating the GenAI based solution corresponding to the received request based on the generated vector representation of the plurality of data segments comprises:
mapping, by the processor, the generated vector representation with at least one vector representation of the pre-stored plurality of data segments;
generating, by the processor, an embedded response comprising the mapped data segments and a part of the received request;
determining, by the processor, whether the generated embedded response comply with a predefined organization rules; and
converting, by the processor, the generated embedded response to a LLM readable file based on results of determination.

18. The method of claim 11, wherein validating the GenAI based solution using the at least one LLM comprises:
determining, by the processor, an intent of the received request from the user by parsing contents of the received request;
determining, by the processor, a LLM for validating the GenAI based solution based on the determined intent and by comparing the contents of the received request with a plurality of pre-stored LLM descriptions;
determining, by the processor, a token usage limit of the determined LLM by accessing LLM properties of the determined LLM;
routing, by the processor, the GenAI based solution to the determined LLM for validation;
applying, by the processor, trained large language models (LLMs) to the GenAI based solution based on the determined intent;
determining, by the processor, a confidence score associated with the GenAI based solution based on results of application of the trained LLMs;
updating, by the processor, the GenAI based solution based on the determined confidence score; and
generating, by the processor, a response to the received request, wherein the response comprises the updated GenAI based solution.

19. The method of claim 11, wherein generating the GenAI I based solution comprises performing, by the processor, at least one of:
generating, by the processor, answers to at least one question from the user using a vector database;
generating, by the processor, answers to automated voice mails;
generating, by the processor, a summary of the automated voice calls;
generating, by the processor, a document on root cause analysis of a use case;
generating, by the processor, a plurality of test cases from a plurality of user stories;
generating, by the processor, an explanation of a code;
generating, by the processor, a test data for test cases;
co-relating, by the processor, the test cases with the plurality of user stories;
analyzing, by the processor, a large relational data and recommending decisions;
analyzing, by the processor, diagrams in architecture documents;
generating, by the processor, documents from a chat history;
generating, by the processor, a document from a template,
generating, by the processor, a source code from a requirement document;
generating, by the processor, a plurality of artificial intelligence (AI)-based insights from an indexed data; and
generating, by the processor, workflows for the use case, wherein the workflows are generated using code scripts and wherein the code scripts are generated using prompts.

20. A non-transitory computer readable medium comprising a processor-executable instructions that cause a processor to:
receive a request for generating a generative AI (GenAI) based solution from a user, wherein the request comprises a query associated with at least one of a use case, a domain, and product requirements;
classify the received request into a plurality of solution patterns, wherein each solution pattern indicates a type of GenAI based solution to be generated for the request;
perform a plurality of actions corresponding to at least one of the plurality of solution patterns based on the received request;
extract a metadata from the received request and the plurality of actions based on the type of GenAI based solution to be generated;
segment the extracted metadata into a plurality of data segments based on the plurality of solution patterns, and the request;
generate a vector representation of the plurality of data segments by embedding the plurality of data segments using a vector-based machine learning model;
generate the GenAI based solution corresponding to the received request based on the generated vector representation of the plurality of data segments;
provide a response source for the GenAI based solution with a confidence level;
validate the GenAI based solution using at least one large language model (LLM);
continuously update the at least one LLM and the vector-based machine learning model with the validated GenAI based solution and a user feedback corresponding to the validated GenAI based solution; and
output the GenAI based solution to the received request on a user interface of a user interface.
